(19) United States
(12) Patent Application Publication
(10) Pub. No.: US 2004/0030093 A1
(43) Pub. Date: Feb. 12, 2004

(54) Metal catalyst for ring-opening polymerization of heterocyclic compound

(76) Inventors: Yoko Sakurai, Kyoto-shi (JP); Munekazu Satake, Kyoto-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/381,433

(22) PCT Filed: Sep. 28, 2001
(86) PCT No.: PCT/JP01/08556

(30) Foreign Application Priority Data
Sep. 28, 2000 (JP) 2000-297413

(51) Int. Cl. C08G 59/68; C08G 65/04; C07F 1/00

(52) U.S. Cl. 528/410; 556/1

(57) ABSTRACT

The object of the present invention is to provide a metal catalyst which allows the production of a ring-opened polymer available from a heterocyclic compound, having primary terminal heteroatomic groups (terminal hydroxyl groups, in particular) in a ratio exceeding 75%.

The above object can be attained by using a metal catalyst comprising a ligand and a metal atom for ring-opening polymerization of heterocyclic compounds

in which, of all maximum angles (D) meeting the following definition, the smallest maximum angle (Dm) is not larger than 60 degrees;

The maximum angle (D) is the largest angle between an imaginary line (X) and an imaginary line (Y) of all the angles which can be assumed in a metal catalyst comprising a ligand and a metal atom,

said imaginary line (X) means a line perpendicular to an imaginary plane (P) including the respective centers of 3 coordinating atoms among those directly coordinating the metal atom (M) and not substitutable by a reaction substrate (S) and passing through the center of the metal atom,

said imaginary line (Y) means a line linking the center of a non-coordinating atom in the ligand and the center of the metal atom,

and said maximum angle (D) exists in a number equal to the number of non-coordinating atoms, that is, the number of imaginary lines (Y).

### TECHNICAL FIELD

The present invention relates to a metal catalyst for ring-opening polymerization of heterocyclic compounds.

### BACKGROUND ART

As catalysts capable of increasing the ratio of primary terminal heteroatomic groups (terminal hydroxyl groups, in particular) of the polymer obtainable by ring-opening polymerization of a heterocyclic compound, tris(pentafluorophenyl)borane, tris(pentafluorophenyl)aluminum, tri(t-butyl)borane, and tris(t-butyl)aluminum are known (Japanese Patent No. 3076032).

However, even with such a catalyst, only polymers having primary functional groups in a ratio of about 70% at best can be obtained, with the result that when used as starting materials for urethane foams, for instance, these polymers are deficient in the reactivity with isocyanates.

### SUMMARY OF THE INVENTION

The object of the present invention, therefore, is to provide a metal catalyst which allows the production of a ring-opened polymer available from a heterocyclic compound, having primary terminal heteroatomic groups (terminal hydroxyl groups, in particular) in a ratio exceeding 75%.

After intensive studies for accomplishing the above object, the inventors of the present invention found that the ratio of primary terminal heteroatomic groups can be increased by using a metal catalyst having a defined stereo-structure.

Thus, the feature of the metal catalyst for ring-opening polymerization of heterocyclic compounds according to the invention resides in a metal catalyst comprising a ligand and a metal atom for ring-opening polymerization of heterocyclic compounds

in which, of all maximum angles (D) meeting the following definition, the smallest maximum angle (Dm) is not larger than 60 degrees;

The maximum angle (D) is the largest angle between an imaginary line (X) and an imaginary line (Y) of all the angles which can be assumed in a metal catalyst comprising a ligand and a metal atom,

said imaginary line (X) means a line perpendicular to an imaginary plane (P) including the respective centers of 3 coordinating atoms among those directly coordinating the metal atom (M) and not substitutable by a reaction substrate (S) and passing through the center of the metal atom,

said imaginary line (Y) means a line linking the center of a non-coordinating atom in the ligand and the center of the metal atom,

and said maximum angle (D) exists in a number equal to the number of non-coordinating atoms, that is, the number of imaginary lines (Y).

### BRIEF DESCRIPTION OF THE DRAWINGS

FIG. 1 is a schematic illustration showing the maximum angle that can be assumed between an imaginary line (X) and an imaginary line (Y).

FIG. 2 is a schematic illustration showing imaginary planes P.

Explanation of Letters

X: an imaginary line (X)

Y: an imaginary line (Y)

Y₁: the imaginary line (Y) constituting the maximum angle (D)

M: the metal atom

S: the reaction substrate (S)

●: the coordinating atom not substitutable by the reaction substrate (S)

◯: the coordinating atom substitutable by the reaction substrate (S)

### DISCLOSURE OF INVENTION

The maximum angle (D) is first explained.

The maximum angle (D) means the largest angle which can be assumed between the imaginary line (X) and the imaginary line (Y), and exists in a number equal to the number of non-coordinating atoms, that is, all the atoms except the atoms directly coordinating the metal atom in the ligand (coordinating atom). Namely, it exists in the number equal to the number of imaginary lines (Y).

The imaginary line (X) means the line assumed to perpendicularly intersect an imaginary plane (P) and pass through the center of the metal atom. And it also means that, along this imaginary line (X), the direction of approach of the reaction substrate (S) exists on the opposite side of the imaginary plane (P) with respect to the metal atom (in the case where the center of the metal atom exists in the imaginary plane (P), either one direction with respect to the imaginary plane (P)). Stated differently, the vacant orbital of the metal atom or the coordinating atom substitutable by the reaction substrate (S) exists in this direction. It is to be understood that said vacant orbital or said substitutable coordinating atom does not necessarily exist on the imaginary line (X) but all that is necessary is that said vacant orbital or substitutable coordinating atom should exist on the opposite side of the imaginary plane (P) with respect to an imaginary plane (P′) which is parallel to the imaginary plane (P) and including the center of the metal atom (in the case where the center of the metal atom exists in the imaginary plane (P), either one side of the imaginary plane (P)).

The imaginary plane (P) is a plane assumed to include the centers of 3 coordinating atoms among those coordinating atoms not substitutable by a heterocyclic compound, which is the reaction substrate (S), and directly coordinating the metal atom (M).

The atom substitutable by the heterocyclic compound (S), referred to above, means a coordinating atom which can be substituted by the heterocyclic compound and includes a halogen atom, a hydrogen atom, and the carbon atom in a cyano group (to be substituted as cyano), among others.

In the case where 3 or more such coordinating atoms exist, the maximum angle (D′) is determined for each imaginary plane (P′) and the smallest maximum angle (Dm′) is selected for each imaginary plane (P′). Then, arbitrary 3 atoms among those which gives the smallest maximum angles (Dm′) are selected and the plane including the centers of these atoms is regarded as the imaginary plane (P) and the smallest maximum angle (Dm′) among them is regarded as the smallest maximum angle (Dm).

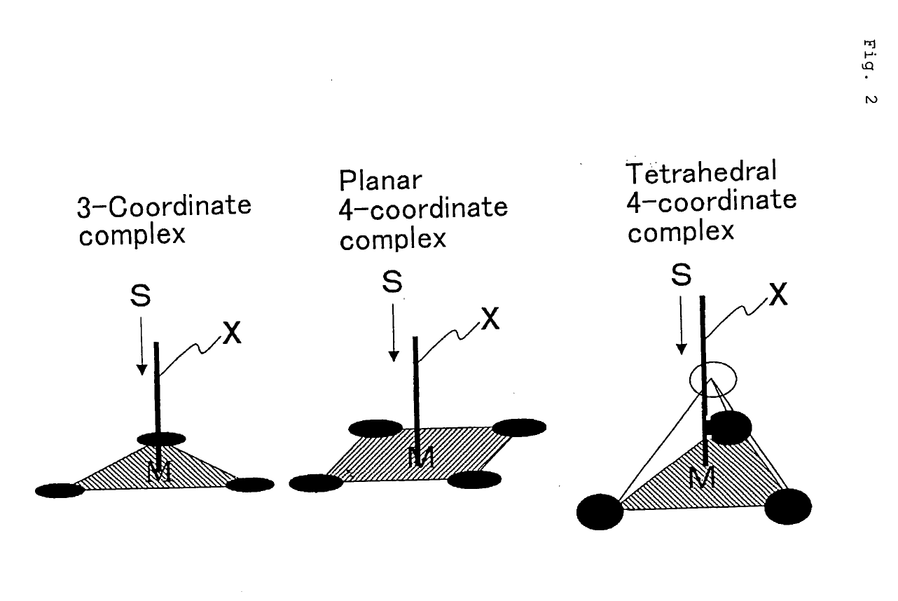

Referring to the schematic views of FIG. 2 illustrating the imaginary planes (P) for the 3-coordinate complex, planar 4-coordinate complex, and tetrahedral 4-coordinate complex, the plane (shaded area) including the centers of 3 coordinating atoms (●: closed circles) except the coordinating atom (◯: open circle) substitutable by the reaction substrate (S) is the imaginary plane (P).

The imaginary line (Y) is an imaginary line passing through the center of a non-coordinating atom in the ligand and the center of the metal atom (M), and exists in a number at least equal to the number of non-coordinating atoms. Thus, in the case that a non-coordinating atom is free to rotate, the number of imaginary lines (Y) existing for the particular non-coordinating atom is infinite.

The largest angle that can be assumed means the angle when it becomes largest during rotation of a freely-rotatable group within the ligand.

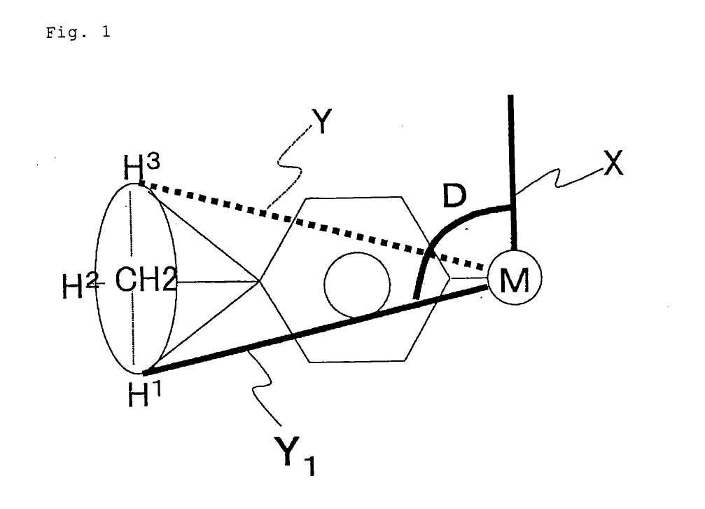

The largest angle that can be assumed is further explained below, referring to the schematic view of FIG. 1 which shows a part of a catalyst comprising a metal atom (M) and a p-methylphenyl group as a ligand.

Referring to one of the hydrogen atoms of the methyl group, the methyl group is free to rotate between the carbon atom in the para-position of the benzene ring and the methyl carbon atom and, therefore, there is an infinite number of imaginary lines linking the metal atom (M) and each hydrogen atom in the methyl group (for example, M-H¹, M-H², M-H³). The angle between an imaginary line (X) and an imaginary line (Y₁) (M-H¹) is the maximum angle (D) for this methyl hydrogen.

In the present invention, the smallest maximum angle (Dm) of the metal catalyst is not larger than 60 degrees, preferably 40 to 60 degrees, more preferably 42 to 59 degrees, still more preferably 43 to 56 degrees, particularly preferably 44 to 53 degrees, most preferably 45 to 50 degrees. When the above range is exceeded, the reaction field is so broad that the ratio of primary terminal heteroatomic groups tends to be hard to improve.

The smallest maximum angle (Dm) can be determined by molecular dynamics computation (MM2) (T. Clark: A Handbook of Computational Chemistry, Maruzen; Sakurai, M & Ikai, A.: Seibutsu-kogaku Kiso Course, Keisan-ki-kagaku Nyumon (Fundamental Course in Biotechnology, Introduction to Computerized Chemistry), Maruzen).

As the metal atom (M) for use in the present invention, any metal atom that can be used for ring-opening polymerization of heterocyclic compounds can be used without particular restriction; thus the metals of Groups 3 to 15 of Periodic Table of the Elements, among others, can be employed (in the context of the present invention, elements which are not generally classified as metals are also dealt with as metals for convenience's sake).

The Group 3 metal includes not only scandium (Sc) and yttrium (Y) but also lanthanoids such as lanthanum (La), cerium (Ce), praseodymium (Pr), neodymium (Nd), promethium (Pm), and samarium (Sm), and actinoids such as thorium (Th), protactinium (Pa), and uranium (U).

The Group 4 metal includes titanium (Ti), zirconium (Zr) and hafnium (Hf).

The Group 5 metal includes vanadium (V), niobium (Nb) and tantalum (Ta).

The Group 6 metal includes chromium (Cr), molybdenum (Mo), and tungsten (W).

The Group 7 metal includes manganese (Mn), technetium (Tc), and rhenium (Re).

The Group 8 metal includes iron (Fe), ruthenium (Ru), and osmium (Os).

The Group 9 metal includes cobalt (Co), rhodium (Rh), and iridium (Ir).

The Group 10 metal includes nickel (Ni), palladium (Pd), and platinum (Pt).

The Group 11 metal includes copper (Cu), silver (Ag), and gold (Au).

The Group 12 metal includes zinc (Zn), cadmium (Cd), and mercury (Hg).

The Group 13 metal includes boron (B), aluminium (Al), gallium (Ga), indium (In) and thallium (Tl).

The Group 14 metal includes tin (Sn) and lead (Pb).

The Group 15 metal includes phosphorus (P), arsenic (As), antimony (Sb), and bismuth (Bi).

Among these, Group 3, Group 4 and Group 13 metals are preferred, and yttrium (Y), samarium (Sm), titanium (Ti), zirconium (Zr), hafnium (Hf), boron (B), and aluminium (Al) are more preferred. Particularly preferred are boron (B) and aluminium (Al), with boron (B) being the best choice. The preferred metals are those having electronegativity values from 8 to 16.

Referring to the ligand, provided that either one or two or more ligands may coordinate the metal atom with the smallest maximum angle (Dm) within the above-mentioned range, whichever desired of an organic and an inorganic ligand can be employed.

When two or more ligands are used, these may be ligands of either the same kind or different kinds and such ligands may have been coupled to each other.

As organic ligands, monodentate, bidentate, tridentate, quadridentate, pentadentate, hexadentate and other ligands can be employed.

As the monodentate ligand, substituent-type ligands (e.g. hydrocarbon groups, sulfonyl, alkoxyl, aryloxy, thioxy, alkylcarbonyloxy, amino, etc.) and compound-type ligands (ketones, aldehydes, acetals, lactones, acid anhydrides, alcohols, amides, ethers, phosphorus compounds, sulfur compounds, unsaturated hydrocarbons (in which π-electrons coordinate), etc.) can be employed.

The hydrocarbon groups may, for example, be alkyl, alkenyl, aryl, cycloalkyl and cycloalkenyl groups.

The alkyl which can be used in the invention includes alkyls containing 1 to 34 (preferably 3 to 20, more preferably 5 to 15) carbon atoms which may optionally be substituted by alkoxy, nitro, cyano, aryl, and/or halogen (said alkoxy and aryl may be substituted by nitro, cyano and/or halogen, for instance; the same applies hereinafter). For example, there can be mentioned methyl, ethyl, propyl, isopropyl, butyl, isobutyl, sec-butyl, t-butyl, pentyl, isopentyl, sec-pentyl, neopentyl, t-pentyl, hexyl, sec-hexyl, heptyl, sec-heptyl, octyl, 2-ethylhexyl, sec-octyl, nonyl, sec-nonyl, decyl, sec-decyl, undecyl, sec-undecyl, dodecyl, sec-dodecyl, tridecyl, isotridecyl, sec-tridecyl, tetradecyl, sec-tetradecyl, hexadecyl, sec-hexadecyl, stearyl, eicosyl, docosyl, tetracosyl, triacontyl, 2-butyloctyl, 2-butyldecyl, 2-hexyloctyl, 2-hexyldecyl, 2-octyldecyl, 2-hexyldodecyl, 2-octyldodecyl, 2-decyltetradecyl, 2-dodecylhexadecyl, 2-hexadecyloctadecyl, 2-tetradecyloctadecyl, isostearyl, perfluorobutyl, perfluoroeicosyl, ethoxymethyl, cyclohexenylethyl, nitropentyl, cyanododecyl, benzyl, phenethyl, styryl, cinnamyl, benzhydryl and trityl, among others.

The alkenyl which can be used in the invention includes alkenyls containing 2 to 20 (preferably 2 to 10, more preferably 2 to 8) carbon atoms which may optionally be substituted by alkoxy, nitro, cyano, aryl and/or halogen, for instance. For example, there can be mentioned vinyl, propenyl, butenyl, isobutenyl, pentenyl, isopentenyl, hexenyl, heptenyl, octenyl, nonenyl, decenyl, undecenyl, dodecenyl, tetradecenyl, oleyl, eicosenyl and dichlorovinyl, among others.

The aryl which can be used in the invention includes aryls containing 6 to 20 (preferably 6 to 15, more preferably 6 to 10) carbon atoms which may optionally be substituted by alkyl, alkoxy, alkenyl, nitro, cyano, aryl, and/or halogen, for instance. For example, there can be mentioned phenyl, tolyl, xylyl, cumenyl, mesityl, ethylphenyl, propylphenyl, butylphenyl, t-butylphenyl, 1,3,5-trimethylphenyl, pentylphenyl, hexylphenyl, heptylphenyl, octylphenyl, nonylphenyl, decylphenyl, undecylphenyl, dodecylphenyl, phenylphenyl, benzylphenyl, p-cumylphenyl, α-naphthyl, β-naphthyl, pentafluorophenyl, heptylfluoronaphthyl, trifluoromethylphenyl, trifluoromethylnaphthyl, perfluoromethylphenyl, 3-methyltetrafluorophenyl, p-trifluoromethyltetrafluorophenyl, 3,5-dimethyltrifluorophenyl, 2,4,5-trifluoromethylphenyl, 3,5-di[t-butyl]phenyl, 2,3,5-trimethylphenyl, indenyl, azulenyl, fluorenyl, phenanthrenyl, anthracenyl, acenaphthylenyl, biphenylenyl, naphthacenyl, pyrenyl, triphenylenyl, and perfluoro-3,4,5-tripropylphenyl, among others.

The cycloalkyl which can be used in the invention includes cycloalkyls containing 5 to 20 (preferably 5 to 15, more preferably 5 to 10) carbon atoms which may optionally be substituted by alkyl, alkoxy, alkenyl, nitro, cyano, aryl, and/or halogen, for instance. For example, there can be mentioned cyclopentyl, cyclohexyl, cycloheptyl, methylcyclopentyl, methylcyclohexyl, methylcycloheptyl, dodecylcyclohexyl, 2,3,4-tripropylcyclohexyl, 2-methylcyclohexyl, 3,5-dimethylcyclohexyl, 2,4,6-trimetylcyclohexyl, methoxycyclohexyl, dichlorocyclopentyl, and perfluorocyclohexyl, among others.

The cycloalkenyl which can be used in the invention includes cycloalkenyls containing 5 to 20 (preferably 5 to 15, more preferably 5 to 10) carbon atoms which may optionally be substituted by alkyl, alkoxy, alkenyl, nitro, cyano, aryl, and/or halogen, for instance. For example, there can be mentioned cyclopentenyl, cyclohexenyl, cycloheptenyl, methylcyclopentenyl, methylcyclohexenyl, methylcycloheptenyl, dodecylcyclohexenyl, cyclooctenyl, 2,3,4-trimethylcyclohexenyl, and dichlorocyclopentenyl, among others.

The sulfonyl which can be used in the invention includes sulfonyls containing 1 to 20 (preferably 1 to 10, more preferably 1 to 5) carbon atoms which may optionally be substituted by alkyl, alkoxy, alkenyl, nitro, cyano, aryl, and/or halogen, for instance. For example, methylsulfonyl, ethylsulfonyl, phenylsulfonyl, and trifluoromethylsulfonyl, among others, can be mentioned.

The alkoxyl which can be used in the invention includes alkoxies containing 1 to 20 (preferably 1 to 15, more preferably 1 to 10) carbon atoms which may optionally be substituted by alkyl, alkoxy, alkenyl, nitro, cyano, aryl, and/or halogen, for instance. For example, there can be mentioned methoxy, ethoxy, n-propoxy, isopropoxy, n-butoxy, sec-butoxy, t-butoxy, n-pentyloxy, n-hexyloxy, 2-ethylhexyloxy, n-octadecyloxy, cyclopentyloxy, cyclohexyloxy, 4-t-butylcyclohexyloxy, cycloheptyloxy, cyclooctyloxy, cyclohexylmethoxy, 2-ethoxyethoxy, 3-methoxypropoxy, 3-ethoxypropoxy, 3-n-propoxypropoxy, 3-n-butoxypropoxy, 3-n-hexyloxypropoxy, 2-methoxyethoxyethoxy, 2-phenoxymethoxy, 2-phenoxyethoxy, eicosyloxy, 3-chloropropoxy, 2,2,2-trichloroethoxy, trifluoromethoxy, and perfluorodecyloxy, among others.

The aryloxy which can be used in the invention includes aryloxies containing 6 to 20 (preferably 6 to 15, more preferably 6 to 10) carbon atoms which may optionally be substituted by alkyl, alkoxy, alkenyl, nitro, cyano, aryl, and/or halogen, for instance. For example, there can be mentioned phenoxy, cresyloxy, 2,3,4-trimethylphenoxy, 2,3,4-trinitrophenoxy, p-chlorophenoxy, pentachlorophenoxy, p-cyanophenoxy, 2,3-xylyloxy, p-decylphenoxy, p-trifluoromethylphenoxy, pentafluorophenoxy, heptafluoronaphthyloxy, and 3,4,5,6-tetrapropylnaphthyloxy, among others.

The thioxy which can be used in the invention includes thioxies containing 1 to 20 (preferably 5 to 20, more preferably 5 to 10) carbon atoms which may optionally be substituted by alkyl, alkoxy, alkenyl, cyano, aryl, and/or halogen, for instance. For example, there can be mentioned methylthioxy, ethylthioxy, propylthioxy, isopropylthioxy, n-butylthioxy, 2-ethylhexylthioxy, allylthioxy, benzylthioxy, octadecylthioxy, cyclohexylthioxy, and eicosylthioxy, among others.

The alkylcarbonyloxy which can be used in the invention includes alkylcarbonyloxy groups containing 2 to 20 (preferably 5 to 20, more preferably 5 to 10) carbon atoms which may optionally be substituted by alkoxy, alkenyl, cyano, aryl, and/or halogen, for instance. For example, there can be mentioned alkylcarbonyloxy groups derived from acetic acid, propanoic acid, caproic acid, cyclohexanecarboxylic acid, benzoic acid, bromoacetic acid, 2-hydroxypropanoic acid, butan-3-onic acid, eicosanoic acid, 2-hexyldocosanoic acid, naphthylhexanoic acid, trichloroethanoic acid, p-nitrobenzylbenzoic acid, cyanoacetic acid, etc. among others.

The amino which can be used includes alkylamino, cycloamino and the like.

The alkylamino which can be used in the invention includes alkylamino groups containing 1 to 20 (preferably 1 to 10, more preferably 1 to 5) carbon atoms in the alkyl moiety and may optionally be substituted by alkoxy, alkenyl, nitro, cyano, aryl, and/or halogen, for instance. For example, there can be mentioned methylamino, dimethylamino, ethylamino, diethylamino, methylethylamino, propylamino, isopropylamino, butylamino, isobutylamino, dipropylamino, dibutylamino, ditetradecylamino, dicyclohexylamino, 1-ethylpropylamino, tetrachlorodiethylamino, diethenylamino, nitrobenzylamino, and the like.

The cycloamino which can be used in the invention includes those cyclic amino groups containing 4 to 20 (preferably 4 to 15, more preferably 4 to 10) carbon atoms which may optionally be substituted by alkyl, alkoxy, alkenyl, nitro, cyano, aryl, and/or halogen, for instance. For example, there can be mentioned anilino, p-chloroanilino, o-toluylamino, 2,3-xylynoamino, 3,4-xylynoamino, α,α′-dimethylpyrrolino, dimethylanilino, methylethylanilino, pyridino, benzoquinolylamino, diphenylamino, methylphenylamino, ethylphenylamino, 3,4-dipentylanilino, 1-pyrrolidinyl, 3-methyl-1-piperidinyl, 1-pyrrolyl, 1-indolyl, 1-piperidyl, 1-piperazinyl, 4-methyl-1-piperazinyl, 1-imidazolidinyl, and morpholinyl, among others.

The ketone which can be used in the invention includes ketones containing 3 to 20 (preferably 3 to 15, more preferably 3 to 10) carbon atoms which may optionally be substituted by alkyl, alkoxy, alkenyl, nitro, cyano, aryl, and/or halogen, for instance. For example, there can be mentioned acetone, ethyl methyl ketone, propyl methyl ketone, isopropyl methyl ketone, butyl methyl ketone, pinacolone, diethyl ketone, butyrone, methyl vinyl ketone, methylheptanone, cyclobutanone, cyclopentanone, cyclohexanone, acetophenone, propiophenone, butyrophenone, valerophenone, benzophenone, acetothienone, 2-acetofuron, ethyl octadecyl ketone, trichloromethyl ethyl ketone, nitrohexyl methyl ketone, and cyanobutyl ethyl ketone, among others.

The aldehyde which can be used in the invention includes aldehydes containing 1 to 20 (preferably 1 to 10, more preferably 1 to 5) carbon atoms which may optionally be substituted by alkyl, alkoxy, alkenyl, nitro, cyano, aryl, and/or halogen, for instance. For example, there can be mentioned formaldehyde, acetaldehyde, propionaldehyde, butyraldehyde, isobutyraldehyde, valeraldehyde, isovaleraldehyde, pivalaldehyde, capraldehyde, heptaldehyde, caprylaldehyde, undecylaldehyde, lauraldehyde, acrolein, crotonaldehyde, propiolaldehyde, benzaldehyde, o-tolualdehyde, m-tolualdehyde, p-tolualdehyde, salicylaldehyde, cinnamaldehyde, α-naphthaldehyde, β-naphthaldehyde, furfuraldehyde, eicosylaldehyde, trichloropropionaldehyde, nitrobenzylaldehyde, and cyclohexyl-3-cyanaldehyde, among others.

The acetal includes acetals containing 3 to 20 (preferably 3 to 15, more preferably 3 to 10) carbon atoms which may optionally be substituted by alkyl, alkoxy, alkenyl, nitro, cyano, aryl, and/or halogen, for instance. Examples of such groups include the dimethyl acetal, methyl ethyl acetal, diethyl acetal, dipropyl acetal, ethyl butyl acetal, cyclohexyl butyl acetal, perchlorodiethyl acetal, cyanodimethyl acetal, etc. of any of the above-mentioned aldehydes.

The lactone which can be used in the invention includes lactones containing 1 to 20 (preferably 1 to 15, more preferably 4 to 10) carbon atoms which may optionally be substituted by alkyl, alkoxy, alkenyl, nitro, cyano, aryl, and/or halogen, for instance. For example, butyrolactone, valerolactone, tetrahydro-2-furanone, tetrahydro-2-pyrone, benzofuranone, perchloro-2-pyrone, and phthalide, among others, can be mentioned.

The acid anhydride which can be used in the invention includes acid anhydrides containing 1 to 20 (preferably 1 to 15, more preferably 4 to 10) carbon atoms which may optionally be substituted by alkyl, alkoxy, alkenyl, nitro, cyano, aryl, and/or halogen, for instance. For example, acetic anhydride, malonic anhydride, phthalic anhydride, succinic anhydride, maleic anhydride, citraconic anhydride, hexanoic anhydride, and 4-cyclohexene-1,2-dicarboxylic anhydride, etc. can be mentioned.

The alcohol which can be used in the invention includes alcohols containing 1 to 20 (preferably 1 to 15, more preferably 1 to 10) carbon atoms which may optionally be substituted by alkyl, alkoxy, alkenyl, nitro, cyano, aryl, and/or halogen, for instance. For example, there can be mentioned methanol, ethanol, n-propanol, isopropyl alcohol, n-butanol, sec-butanol, t-butyl alcohol, n-pentanol, n-hexanol, 2-ethylhexanol, n-octadecanol, cyclopentanol, cyclohexanol, 4-t-butylcyclohexanol, cycloheptanol, cyclooctanol, cyclohexylmethanol, 2-ethoxyethanol, 3-methoxypropanol, 3-ethoxypropanol, 3-n-propoxypropanol, 3-n-butoxypropanol, 3-n-hexyloxypropanol, 2-methoxyethoxyethanol, 2-phenoxymethanol, 2-phenoxyethanol, eicosanol, 3-chloropropanol, 2,2,2-trichloroethanol, trifluoromethanol, and perfluorodecanol, among others.

The amide which can be used in the invention includes amides containing 1 to 20 (preferably 2 to 15, more preferably 2 to 15) carbon atoms which may optionally be substituted by alkyl, alkoxy, alkenyl, cyano, aryl, and/or halogen, for instance. For example, there can be mentioned formamide, N,N-dimethylformamide, N-methylpyrrolidone, N-phenyl-N′-methylurea, N,N-didodecylformamide, hexanoic amide, and benzenesulfonamide, among others.

The ether ligand which can be used in the invention includes ethers containing 2 to 60 (preferably 2 to 15, more preferably 2 to 10) carbon atoms which may optionally be substituted by alkyl, alkenyl, cyano, aryl, and/or halogen, for instance. For example, there can be mentioned dimethyl ether, diethyl ether, dipropyl ether, diisopropyl ether, dibutyl ether, diisobutyl ether, di-n-amyl ether, diisoamyl ether, methyl ethyl ether, methyl propyl ether, methyl isopropyl ether, methyl butyl ether, methyl n-amyl ether, methyl vinyl ether, methyl allyl ether, ethyl vinyl ether, ethyl allyl ether, anisole, phenetole, diphenyl ether, dibenzyl ether, phenyl benzyl ether, α-naphthyl methyl ether, β-naphthyl methyl ether, dioxane, tetrahydrofuran, dodecyl phenyl ether, dodecyl naphthyl ether, perchlorodimethyl ether, ethyl cyclohexenyl ether, ethyl cyanidomethyl ether, 12-4 crown ether, 15-4 crown ether, 15-5 crown ether, 18-6 crown ether, dibenzo-18-6 crown ether, di(triphenanthryl)dinonyl-18-6 crown ether, and perhydrodibenzo-18-6 crown ether, among others.

The phosphorus compound which can be used in the invention includes phosphine compounds containing 1 to 20 (preferably 1 to 10, more preferably 1 to 5) carbon atoms which may optionally be substituted by alkyl, alkoxy, alkenyl, cyano, aryl, and/or halogen, for instance. For example, there can be mentioned methylphosphine, ethylphosphine, dimethylphosphine, triphenylphosphine, methyldiphenylphosphine, trimethylphosphine, trispentafluorophenylphosphine, tristrifluoromethylphenylphosphine, methoxyphenyldiphenylphosphine, triethyl phosphite, trisnitrobenzyl phosphite, and dimethylcyanoethylphosphine, among others.

The sulfur compound which can be used in the invention includes thiols, sulfides, thioaldehydes, thioketones, and thioacetals.

The thiol which can be used in the invention includes thiols containing 1 to 20 (preferably 5 to 20, more preferably 5 to 10) carbon atoms which may optionally be substituted by alkyl, alkoxy, alkenyl, cyano, aryl, and/or halogen, for instance. For example, there can be mentioned methylthiol, ethylthiol, propylthiol, isopropylthiol, n-butylthiol, 2-ethylhexylthiol, allylthiol, benzylthiol, octadecylthiol, cyclohexylthiol, and eicosylthiol, among others.

The sulfide which can be used in the invention includes sulfides containing 2 to 20 (preferably 5 to 20, more preferably 5 to 10) carbon atoms which may optionally be substituted by alkyl, alkoxy, alkenyl, cyano, aryl, and/or halogen, for instance. For example, there can be mentioned dimethyl sulfide, diethyl sulfide, methyl propyl sulfide, methylthionaphthalene, propylthioanthracene, bis-p-methoxyphenyl sulfide, perchlorodiphenyl sulfide, cyclopentenyl methyl sulfide, cyanomethyl ethyl sulfide, and bisnitrotoluenyl sulfide, among others.

The thioaldehyde which can be used in the invention includes thioaldehydes containing 1 to 20 (preferably 1 to 10, more preferably 1 to 5) carbon atoms which may optionally be substituted by alkyl, alkoxy, alkenyl, cyano, aryl, and/or halogen, for instance. For example, there can be mentioned formthioaldehyde, acetthioaldehyde, propionthioaldehyde, butyrthioaldehyde, isobutyrthioaldehyde, valerthioaldehyde, isovalerthioaldehyde, pivalinthioaldehyde, capronthioaldehyde, heptthioaldehyde, caprylthioaldehyde, undecylthioaldehyde, laurylthioaldehyde, thioacrolein, crotonthioaldehyde, propiolthioaldehyde, benzthioaldehyde, o-toluthioaldehyde, m-toluthioaldehyde, p-toluthioaldehyde salicvilthioaldehyde, cinnamthioaldehyde, α-naphthothioaldehyde, β-naphtothioaldehyde, furfuralthioaldehyde, eicosyl thioaldehyde, trichloropropionthlioaldehyde, nitrobenzyl thioaldehyde, and cyclohexyl-3-cyanothioaldehyde, among others.

The thioketone which can be used in the invention includes thioketones containing 3 to 20 (preferably 3 to 15, more preferably 3 to 10) carbon atoms which may optionally be substituted by alkyl, alkoxy, alkenyl, nitro, cyano, aryl, and/or halogen, for instance. For example, there can be mentioned thioacetone, ethyl methyl thione, propyl methyl thione, isopropyl methyl thione, butyl methyl thione, thiopinacolone, diethylthione, butyrothione, methyl vinyl thione, methyl heptyl thione, cyclobutanethione, cyclopentanethione, cyclohexanethione, acetophenylthione, propiophenylthione, butyrophenylthione, valerophenylthione, benzophenylthione, acetothiethione, thio-2-acetofuron, ethyl octadecyl thione, trichloromethyl ethyl thione, nitrohexyl methyl thione, and cyanobutyl ethyl thione, among others.

The thioacetal which can be used in the invention includes thioacetals containing 3 to 20 (preferably 3 to 15, more preferably 3 to 10) carbon atoms which may optionally be substituted by alkyl, alkoxy, alkenyl, nitro, cyano, aryl, and/or halogen, for instance. For example, there can be mentioned dimethyl thioacetal, methyl ethyl thioacetal, diethyl thioacetal, dipropyl thioacetal, ethyl butyl thioacetal, cyclohexyl butyl thioacetal, perchlorodiethyl thioacetal, and cyanodimethyl thioacetal, etc. of the above aldehyde compounds.

The unsaturated hydrocarbon compound (in which the n electrons coordinate) which can be used in the invention includes olefins and aromatic hydrocarbons, among others.

The olefin referred to above includes olefins containing 2 to 20 (preferably 2 to 10, more preferably 2 to 8) carbon atoms which may optionally be substituted by alkoxy, nitro, cyano, aryl, and/or halogen, for instance. For example, there can be mentioned ethylene, propylene, butene, isobutene, pentene, isopentene, hexene, heptene, octene, nonene, decene, undecene, dodecene, tetradecene, octadecene, eicosene, dichloroethylene, nitropentene, 3-cyanocyclohexene, and cyclopentene, among others.

The aromatic hydrocarbon referred to above includes aromatic hydrocarbons containing 6 to 20 (preferably 6 to 15, more preferably 6 to 10) carbon atoms which may optionally be substituted by alkyl, alkoxy, alkenyl, nitro, cyano, and/or halogen, for instance. For example, benzene, naphthalene, chlorobenzene, phenol, nitrophenol, cyanobenzene, tripropylanthracene, cyclopentadiene, and cyclooctene, among others, can be mentioned.

The bidentate ligand includes not only dicarbonyl compounds, diamines, amino acids, modified amines, dienes, aromatic hydrocarbons (coordination is occurred by the π electrons thereof), dioxy, etc., but also bidentate ligands having dissimilar coordinating atoms.

The dicarbonyl compound which can be used in the invention includes diketones and dialdehydes containing 3 to 30 (preferably 3 to 15, more preferably 3 to 10) carbon atoms which may optionally be substituted by alkyl, alkoxy, alkenyl, cyano, aryl, and/or halogen, for instance. For example, there can be mentioned malonaldehyde, succinaldehyde, 2-furaldehyde (furfural), 1,2-aphthalenedicarbaldehyde, acetylacetone, dibenzoylmethane, dipivaloylmethane, hexafluoroacetylacetone, 5,5-dimethyl-1,3-cyclohexanedione, naphthoquinone, anthraquinone, and 9,10-phenanthrenequinone, among others.

The diamine which can be used in the invention includes diamines containing 2 to 20 (preferably 2 to 15, more preferably 2 to 10) carbon atoms which may optionally be substituted by alkyl, alkoxy, alkenyl, cyano, aryl, and/or halogen, for instance. For example, phenanthroline, ethylenediamine, hexamethylenediamine, o-tolidine, indazole, bipyridyl, bathocuproin, benzidine, DABCO, DBM, and DBU, among others, can be mentioned.

The amino acid (ester) referred to above includes amino acids (esters) containing 2 to 20 (preferably 2 to 15, more preferably 2 to 10) carbon atoms which may optionally be substituted by alkyl, alkoxy, alkenyl, nitro, cyano, aryl, and/or halogen, for instance, and these may coordinate as substituent type ligands or compound type ligands.

The substituent type ligand referred to above includes glycinato (NH₂CH₂COO—), alaninato, valinato, leucinato, and prolinato.

The compound type ligand includes glutamic acid, 2-aminobutyric acid, alloisoleucine, isoleucine, phenylalanine, glycine methyl ester, alanine ethyl ester, valine phenyl ester, leucine methyl ester, glutamine cyanomethyl ester, and lysine pentyl ester.

The modified amine referred to above includes oximes and aminecarboxylic acids containing 1 to 30 carbon atoms.

The oxime referred to just above includes dimethylglyoxime, cyclohexane-1,2-dione dioxime, benzyl oxime, and the like.

The aminocarboxylic acid includes ethylenediaminetetraacetato, iminodiacetato, nitritodiacetato complexes, and the like.

The diene referred to above includes dienes containing 4 to 20 (preferably 4 to 15, more preferably 4 to 10) carbon atoms which may optionally be substituted by alkoxy, cyano, aryl, and/or halogen, for instance. For example, butadiene, cyclopentadiene, hexadiene, octadiene, cyclooctadiene, decadiene, octadecadiene, 3-nonyl-6-ethyldeca-1,9-diene, among others, can be mentioned.

The aromatic hydrocarbon referred to above includes aromatic hydrocarbons containing 6 to 20 (preferably 6 to 15, more preferably 6 to 10) carbon atoms which may optionally be substituted by alkyl, alkoxy, alkenyl, nitro, cyano, aryl, and/or halogen, for instance. For Example, benzene, naphthalene, chlorobenzene, phenol, nitrophenol, cyanobenzene, tripropylanthracene, and cyclopentacyclooctene, among others, can be mentioned.

The dioxy referred to above includes dioxy species containing 2 to 20 (preferably 2 to 10, more preferably 2 to 6) carbon atoms. For example, ethylene glycoxy, propylene glycoxy, butylene glycoxy, 1,8-octanedioxy, 2,8-decanedioxy, catechoxy, and 2,18-eicosanedioxy, among others, can be mentioned.

The bidentate ligand having dissimilar coordinating atoms includes ligands in which nitrogen and oxygen, nitrogen and sulfur, or sulfur and oxygen are coordinating atoms.

The ligand having nitrogen and oxygen as coordinating atoms (N—O ligand) which can be used in the invention includes cyclic compounds containing 3 to 20 (preferably 3 to 15, more preferably 3 to 10) carbon atoms. For example, 3-quinolineacetic acid, N-methylindene-2-carbamidic acid, isoxazole, phenoxazine, benzoxazine, aminopyridine, and pyridone, among others, can be mentioned.

The ligand having nitrogen and sulfur as coordinating atoms (N—S ligand) which can be used in the invention includes compounds containing 3 to 20 (preferably 3 to 15, more preferably 3 to 10) carbon atoms. For example, 2-quinolinethiol, 1,3-thiazole, phenylpiperidinyl sulfide, aminothiophenol, aminopyridine, benzothiazoline, 4,7-hydroepithioindole, and ditizone, among others, can be mentioned.

The ligand having sulfur and oxygen as coordinating atoms (S—O ligand) which can be used in the invention includes compounds containing 3 to 20 (preferably 3 to 15, more preferably 3 to 10) carbon atoms, such as thioformylbenzoic acid, thieno[2,3-b]furan, and oxathiolane, among others.

The tridentate ligand which can be used includes triamines, trienes, and aromatic hydrocarbons (coordination is occurred by π electrons thereof), among others.

The triamine referred to just above includes triamines containing 4 to 20 (preferably 4 to 15, more preferably 4 to 10) carbon atoms. For example, diethylenetriamine, N,N′-diethyldiethylenetriamine, N,N′-diphenyldiethylenetriamine, spermidine, 2,2′:6′,2″-terpyridine, and 1,3,5-triazine, among others, can be mentioned.

The triene includes trienes containing 6 to 20 (preferably 6 to 15, more preferably 6 to 10) carbon atoms. For example, hexatriene, octatriene, cyclooctatriene, and eicosatriene, among others, can be mentioned.

The aromatic hydrocarbon includes aromatic hydrocarbons containing 6 to 20 (preferably 6 to 15, more preferably 6 to 10) carbon atoms which may optionally be substituted by alkyl, alkoxy, alkenyl, nitro, cyano, aryl, and/or halogen, for instance. For example, benzene, naphthalene, chlorobenzene, phenol, nitrophenol, cyanobenzene, tripropylanthracene, and cyclopentacyclooctene, among others, can be mentioned.

The tetradentate ligand which can be used includes tetramines, polyethers, and aromatic hydrocarbons (coordination is occurred by the π electrons thereof).

The tetramine referred to above includes tetramines containing 6 to 200 (preferably 10 to 100, more preferably 10 to 60) carbon atoms. For example, there can be mentioned cyclam (1,4,8,11-tetraazacyclotetradecane), mesotetraphenyloctaethylporphyrin, mesotetraphenylporphyrin, α,β-naphthyloctaethylporphyrin, triethylenetetramine, ethylenediaminetetraacetic acid (EDTA), 1,1,2,2-tetramethylethylenediamine, mesotetraphenanthryl-1,2,3,4,5,6,7,8-octadecanecarboxylic acid porphyrin, and phthalocyanine, among others.

The polyether includes crown ethers containing 8 to 60 (preferably 8 to 30, more preferably 8 to 20) carbon atoms. For example, there can be mentioned 12-4 crown ether, 15-4 crown ether, 15-5 crown ether, 18-6 crown ether, dibenzo-18-6 crown ether, di(triphenanthryl)dinonyl-18-6 crown ether, and perhydrodibenzo-18-6 crown ether, among others.

The aromatic hydrocarbon referred to above includes aromatic hydrocarbons containing 6 to 20 (preferably 6 to 15, more preferably 6 to 10) carbon atoms which may optionally be substituted by alkyl, alkoxy, alkenyl, nitro, cyano, aryl, and/or halogen, for instance. For example, benzene, naphthalene, chlorobenzene, phenol, nitrophenol, cyanobenzene, tripropylanthracene, and cyclopentacyclooctene, among others, can be mentioned.

The penta- or hexadentate ligand includes EDTA, tetraethylenepentamine, N,N″-bis(salicylidene)dipropylenetolidinebis(semicarbazone), dibenzo-18-crown-6,18-crown-6, and cryptand[2,2,2], among others.

The preferred, among these organic ligands, are hydrocarbon groups and unsaturated hydrocarbons, with aryl and diene species being still more preferred. Particularly preferred are aryl species which may optionally be substituted by alkyl, alkoxy, alkenyl, nitro, cyano, aryl, and/or halogen, for instance, and dienes which may optionally be substituted by alkoxy, nitro, cyano, aryl, and/or halogen, for instance, with aryl species optionally substituted by alkyl and/or halogen and dienes substituted by halogen being most preferred.

The inorganic ligand is not particularly restricted but the ligands hitherto known can be employed. For example, ammine (NH₃), aqua (H₂O), cyano (CN), carbonyl (CO), nitrosyl (NO), fluoro (F), chloro (Cl), bromo (Br), iodo (I), hydroxy (HO), sulfate ion (SO₄), carbonate ion (CO₃), phosphate ion (PO₄), hydrogenphosphate ion (HPO₄), perchlorate ion (ClO₄), nitrosyl (—SCN), isocyanato (—CNS), nitrate ion (NO₃), etc. can be mentioned.

The coordinate structure of the metal catalyst according to the present invention may be any of the 2-coordinate, 3-coordinate, 4-coordinate, 5-coordinate, and 6-coordinate structures but the 3-coordinate, 4-coordinate, 5-coordinate, and 6-coordinate structures are preferred and the 3-coordinate, 4-coordinate and 6-coordinate structures are still more preferred. Particularly preferred are the 3-coordinate and 6-coordinate structures and most preferred are the 3-coordinate structure.

The following is a partial list of exemplary metal catalysts of the invention. The figure in brackets < > indicates the smallest maximum angle (Dm) of each compound.

As metal catalysts containing the same aryl group as monodentate ligands, there can be mentioned, inter alia, tris(2,3,4,5-tetrafluorotoluyl)yttrium <58.0>, tri(2,3,4,5-tetrafluorotoluyl)samarium <58.0>, tetrakis(2,3,4,5-tetrafluorotoluyl)titanium <53.5>, tetrakis(2,3,4,5-tetrafluorotoluyl)zirconium <53.5>, tetrakis(2,3,4,5-tetrafluorotoluyl)hafnium <53.5>, tris(2,3,4,5-tetrafluorotoluyl)borane <58.0>, tris(2,3,4,5-tetrafluorotoluyl)aluminum <58.0>, pentakis(2,3,4,5-tetrafluorotoluyl)phosphine <40.3>, tris[2,4,6-trifluoro-3,5-di(α,α,α-trifluoromethyl)phenyl]yttrium <53.8>, tris[2,4,6-trifluoro-3,5-di(α,α,α-trifluoromethyl)phenyl]samarium <53.8>, tetrakis[2,4,6-trifluoro-3,5-di(α,α,α-trifluoromethyl)phenyl]titanium <56.0>, tetrakis[2,4,6-trifluoro-3,5-di(α,α,α-trifluoromethyl)phenyl]zirconium <56.0>, tetrakis[2,4,6-trifluoro-3,5-di(α,α,α-trifluoromethyl)phenyl]hafnium <56.0>, pentakis[2,4,6-trifluoro-3,5-(α,α,α-trifluoromethyl)phenyl]phosphine <50.1>, pentakis(2,4-dimethyltetrafluorophenyl)phosphine <42.2>, tris(3-methyltetrafluorophenyl)borane <58.0>, tris(3-methyltetrafluorophenyl)aluminum <58.0>, tris(o-trifluoromethylphenyl)aluminum <54.0>, tetraphenyldichlorophosphine <53.9>, tetrakis(pentafluorophenyl)dichlorophosphine <51.8>, tetraphenyldicyanophosphine <52.7>, and tetraphenyldiiodoantimony <52.1>, among others.

As metal catalysts having an aryl group and another or other aryl and/or non-aryl groups as monodentate ligands, there can be mentioned, inter alia, bis[2,3,5,6-tetrafluoro-p-(α,α,α-trifluoromethyl)phenyl]-t-butylyttrium <56.7>, bis[2,3,5,6-tetrafluoro-p-(α,α,α-trifluoromethyl)phenyl]-t-butylsamarium <56.7>, bis[2,3,5,6-tetrafluoro-p-(α,α,α-trifluoromethyl)phenyl]-t-butyltitanium chloride <59.2>, bis[2,3,5,6-tetrafluoro-p-(α,α,α-trifluoromethyl)phenyl]-t-butylzirconium chloride <59.2>, bis[2,3,5,6-tetrafluoro-p-(α,α,α-trifluoromethyl)phenyl]-t-butylhafnium chloride <59.2>, bis[2,3,5,6-tetrafluoro-p-(α,α,α-trifluoromethyl)phenyl]-t-butylborane <56.7>, bis[2,3,5,6-tetrafluoro-p-(α,α,α-trifluoromethyl)phenyl]-t-butylaluminum <56.7>, tris[2,3,5,6-tetrafluoro-p-(α,α,α-trifluoromethyl)phenyl]-t-butylphosphorus chloride <56.8>, 3-(α,α,α,α′,α′,α′,α″,α″,α″-nonafluoro-t-butyl)phenyl-[2,4-di(trifluoromethyl)trifluorophenyl]-pentafluorophenylyttrium <53.4>, 3-α,α,α,α′,α′,α′,α″,α″,α″-nonafluoro-t-butyl)phenyl-[2,4-di(trifluoromethyl)trifluorophenyl]-pentafluorophenylsamarium <53.4>, 3-(α,α,α,α′,α′,α′,α″,α″,α″-nonafluoro-t-butyl)phenyl-1,3,5-trifluoro[2,4-di(α,α,α-trifluoromethyl)phenyl]-pentafluorophenyltitanium <48.7>, bis[3-(α,α,α,α′,α′,α′,α″,α″,α″-nonafluoro-t-butyl)phenyl]-1,3,5-trifluoro[2,4-di(α,α,α-trifluoromethyl)phenyl]-pentafluorophenylzirconium <48.7>, 3-(α,α,α,α′,α′,α′,α″,α″,α″-nonafluoro-t-butyl)phenyl-1,3,5-trifluoro[2,4-di(α,α,α-trifluoromethyl)phenyl]-pentafluorophenylhalfnium <48.7>, 3-(α,α,α,α′,α′,α′,α″,α″,α″-nonafluoro-t-butyl)phenyl-1,3,5-trifluoro[2,4-di(α,α,α-trifluoromethyl)phenyl]-pentafluorophenylborane <53.4>, 3-(α,α,α,α′,α′,α′,α″,α″,α″-nonafluoro-t-butyl)phenyl-1,3,5-trifluoro[2,4-di(α,α,α-trifluoromethyl)phenyl]-pentafluorophenylaluminum <53.4>, and [3-(α,α,α,α′,α′,α′,α″,α″,α″-nonafluoro-t-butyl)phenyl-1,3,5-trifluoro[2,4-di(α,α,α-trifluoromethyl)phenyl]-tris(pentafluorophenyl)phosphine <45.1>, among others.

As metal catalysts containing an alkyl group as a monodentate ligand, there can be mentioned bis[3-(α,α,α,α′,α′,α′,α″,α″,α″-nonafluoro-t-butyl)phenyl]-t-butylyttrium <54.3>, bis[3-(α,α,α,α′,α′,α′,α″,α″,α″-nonafluoro-t-butyl)phenyl]-t-butylsamarium <54.3>, bis[3-(α,α,α,α′,α′,α′,α″,α″,α″-nonafluoro-t-butyl)phenyl]-bis(t-butyl)titanium <51.9>, bis[3-(α,α,α,α′,α′,α′,α″,α″,α″-nonafluoro-t-butyl)phenyl]-bis(t-butyl)zirconium <51.9>, bis[3-(α,α,α,α′,α′,α′,α″,α″,α″-nonafluoro-t-butyl)phenyl]-bis(t-butyl)hafnium <51.9>, bis[3(α,α,α,α′,α′,α′,α″,α″,α″-nonafluoro-t-butyl)phenyl]-t-butylborane <54.3>, bis[3-(α,α,α,α′,α′,α′,α″,α″,α″-nonafluoro-t-butyl)phenyl]-t-butylaluminum <54.3>, and bis[3-(α,α,α,α′,α′,α′,α″,α″,α″-nonafluoro-tbutyl)phenyl]-t-butylphosphine <54.3>, among others.

As metal catalysts containing an alkenyl group as a monodentate ligand, there can be mentioned bis[3(α,α,α,α′,α′,α′,α″,α″,α″-nonafluoro-t-butyl)phenyl]-cyclohexenylyttrium <58.4>, bis[3-(α,α,α,α′,α′,α′,α″,α″,α″-nonafluoro-t-butyl)phenyl]-cyclohexenylsamarium <58.4>, tris[3(α,α,α,α′,α′,α′,α″,α″,α″-nonafluoro-t-butyl)phenyl]-cyclohexenyltitanium <55.8>, tris[3(α,α,α,α′,α′,α′,α″,α″,α″-nonafluoro-t-butyl)phenyl]-cyclohexenylzirconium <55.8>, tris[3(α,α,α,α′,α′,α′,α″,α″,α″-nonafluoro-t-butyl)phenyl]-cyclohexenylhafnium <55.8>, bis[3(α,α,α,α′,α′,α′,α″,α″,α″-nonafluoro-t-butyl)phenyl]-cyclohexenylborane <58.4>, bis[3(α,α,α,α′,α′,α′,α″,α″,α″-nonafluoro-t-butyl)phenyl]-cyclohexenylaluminum <58.4>, and bis[3(α,α,α,α′,α′,α′,α″,α″,α″-nonafluoro-t-butyl)phenyl]-cyclohexenylphosphine <58.4>, among others.

As metal catalysts containing a ketone group as a monodentate ligand, there can be mentioned bis[3-(α,α,α,α′,α′,α′,α″,α″,α″-nonafluoro-t-butyl)phenyl]-acetophenonatoyttrium <57.6>, bis[3-(α,α,α,α′,α′,α′,α″,α″,α″-nonafluoro-t-butyl)phenyl]-acetophenonatosamarium <57.6>, tris[3-(α,α,α,α′,α′,α′,α″,α″,α″-nonafluoro-t-butyl)phenyl]-acetophenonatotitanium <53.6>, tris[3(α,α,α,α′,α′,α′,α″,α″,α″-nonafluoro-t-butyl)phenyl]-acetophenonatozirconium <53.6>, tris(3-(α,α,α,α′,α′,α′,α″,α″,α″-nonafluoro-t-butyl)phenyl]-acetophenonatohafnium <53.6>, bis[3-(α,α,α,α′,α′,α′,α″,α″,α″-nonafluoro-t-butyl)phenyl]-acetophenonatoborane <57.6>, bis[3-(α,α,α,α′,α′,α′,α″,α″,α″-nonafluoro-t-butyl)phenyl]-acetophenonatoaluminum <57.6>, and bis[3-(α,α,α,α′,α′,α′,α″,α″,α″-nonafluoro-t-butyl)phenyl]-acetophenonatophosphine <57.6>, among others.

As metal catalysts containing an amino group as a monodentate ligand, there can be mentioned bis[3-(α,α,α,α′,α′,α′,α″,α″,α″-nonafluoro-t-butyl)phenyl]-morpholineyttrium <52.5>, bis[3-(α,α,α,α′,α′,α′,α″,α″,α″-nonafluoro-t-butyl)phenyl]-morpholinesamarium <52.5>, tris[3-(α,α,α,α′,α′,α′,α″,α″,α″-nonafluoro-t-butyl)phenyl]-morpholinetitanium <54.9>, [3-(α,α,α,α′,α′,α′,α″,α″,α″-nonafluoro-t-butyl)phenyl]-morpholinezirconium <54.9>, tris[3-(α,α,α,α′,α′,α′,α″,α″,α″-nonafluoro-tbutyl)phenyl]-morpholinehafnium <54.9>, bis[3-(α,α,α,α′,α′,α′,α″,α″,α″-nonafluoro-t-butyl)phenyl]-morpholineborane <52.5>, bis[3-(α,α,α,α′,α′,α′,α″,α″,α″-nonafluoro-t-butyl)phenyl]-morpholinealuminum <52.5>, and bis[3-(α,α,α,α′,α′,α′,α″,α″,α″-nonafluoro-tbutyl)phenyl]-morpholinephosphine <52.5>, among others.

As metal catalysts containing a phosphorus compound as a monodentate ligand, there can be mentioned bis[3-(α,α,α,α′,α′,α′,α″,α″,α″-nonafluoro-t-butyl)phenyl]-trisphenylphosphonium yttrium <52.5>, bis[3-(α,α,α,α′,α′,α′,α″,α″,α″-nonafluoro-t-butyl)phenyl]-trisphenylphosphonium samarium <52.5>, tris[3-(α,α,α,α′,α′,α′,α″,α″,α″-nonafluoro-t-butyl)phenyl]-trisphenylphosphonium titanium <52.3>, tris[3-(α,α,α,α′,α′,α′,α″,α″,α″-nonafluoro-t-butyl)phenyl]-trisphenylphosphonium zirconium <52.3>, tris[3-(α,α,α,α′,α′,α′,α″,α″,α″-nonafluoro-t-butyl)phenyl]-trisphenylphosphonium hafnium <52.3>, bis[3-(α,α,α,α′,α′,α′,α″,α″,α″-nonafluoro-t-butyl)phenyl]-trisphenylphosphonium borane <52.5>, bis[3-(α,α,α,α′,α′,α′,α″,α″,α″-nonafluoro-t-butyl)phenyl]trisphenylphosphonium aluminum <52.5>, and tris[3-(α,α,α,α′,α′,α′,α″,α″,α″-nonafluoro-t-butyl)phenyl]-trisphenylphosphonium phosphine <52.5>, among others.

As metal catalysts containing a sulfur compound as a monodentate ligand, there can be mentioned bis[3(α,α,α,α′,α′,α′,α″,α″,α″-nonafluoro-t-butyl)phenyl]-diphenyl sulfoxide yttrium <58.1>, bis[3-(α,α,α,α′,α′,α′,α″,α″,α″-nonafluoro-t-butyl)phenyl]-diphenyl sulfoxide samarium <58.1>, tris[3-(α,α,α,α′,α′,α′,α″,α″,α″-nonafluoro-t-butyl)phenyl]-diphenyl sulfoxide titanium <58.3>, tris[3-(α,α,α,α′,α′,α′,α″,α″,α″-nonafluoro-t-butyl)phenyl]-diphenyl sulfoxide zirconium <58.3>, tris[3-(α,α,α,α′,α′,α′,α″,α″,α″-nonafluoro-t-butyl)phenyl]-diphenyl sulfoxide hafnium <58.3>, bis[3-(α,α,α,α′,α′,α′,α″,α″,α″-nonafluoro-t-butyl)phenyl]-diphenyl sulfoxide borane <58.1>, bis[3-(α,α,α,α′,α′,α′,α″,α″,α″-nonafluoro-t-butyl)phenyl]-diphenyl sulfoxide aluminum <58.1>, and bis[3-(α,α,α,α′,α′,α′,α″,α″,α″-nonafluoro-t-butyl)phenyl]-diphenyl sulfoxide phosphine <58.1>; bis[3-(α,α,α,α′,α′,α′,α″,α″,α″-nonafluoro-t-butyl)phenyl]-yttrium eicosylthiolate <59.1>, bis[3-(α,α,α,α′,α′,α′,α″,α″,α″-nonafluoro-t-butyl)phenyl]-samarium eicosylthiolate <59.1>, tris[3-(α,α,α,α′,α′,α′,α″,α″,α″-nonafluoro-t-butyl)phenyl]-titanium eicosylthiolate <56.9>, tris[3-(α,α,α,α′,α′,α′,α″,α″,α″-nonafluoro-t-butyl)phenyl]-zirconium eicosylthiolate <56.9>, tris[3-(α,α,α,α′,α′,α′,α″,α″,α″-nonafluoro-t-butyl)phenyl]-hafnium eicosylthiolate <56.9>, bis[3-(α,α,α,α′,α′,α′,α″,α″,α″-nonafluoro-t-butyl)phenyl]-borane eicosylthiolate <59.1>, bis[3-(α,α,α,α′,α′,α′,α″,α″,α″-nonafluoro-t-butyl)phenyl]-aluminum eicosylthiolate <59.1>, and bis[3-(α,α,α,α′,α′,α′,α″,α″,α″-nonafluoro-t-butyl)phenyl]-phosphine eicosylthiolate <59.1>, among others.

As metal catalysts containing a phenoxy group as a monodentate ligand, there can be mentioned bis[3-(α,α,α,α′,α′,α′,α″,α″,α″-nonafluoro-t-butyl)phenyl]-2,3,4,5,6-pentafluorophenoxyyttrium <53.3>, bis[3-(α,α,α,α′,α′,α′,α″,α″,α″-nonafluoro-t-butyl)phenyl]-2,3,4,5,6-pentafluorophenoxysamarium <53.3>, tris[3-(α,α,α,α′,α′,α′,α″,α″,α″-nonafluoro-t-butyl)phenyl]-2,3,4,5,6-pentafluorophenoxytitanium <47.9>, tris[3-(α,α,α,α′,α′,α′,α″,α″,α″-nonafluoro-t-butyl)phenyl]-2,3,4,5,6-pentafluorophenoxyzirconium <47.9>, tris[3-(α,α,α,α′,α′,α′,α″,α″,α″-nonafluoro-t-butyl)phenyl]-2,3,4,5,6-pentafluorophenoxyhafnium <47.9>, bis[3-(α,α,α,α′,α′,α′,α″,α″,α″-nonafluoro-t-butyl)phenyl]-2,3,4,5,6-pentafluorophenoxyborane <53.3>, bis[3-(α,α,α,α′,α′,α′,α″,α″,α″-nonafluoro-t-butyl)phenyl]-2,3,4,5,6-pentafluorophenoxyaluminum <53.3>, and bis[3-(α,α,α,α′,α′,α′,α″,α″,α″-nonafluoro-t-butyl)phenyl]-2,3,4,5,6-pentafluorophenoxyphosphine <53.3>, among others.

As metal catalysts containing an ether as a monodentate ligand, there can be mentioned bis[3-(α,α,α,α′,α′,α′,α″,α″,α″-nonafluoro-t-butyl)phenyl]-yttrium β-naphthyl methyl ether complex <58.1>, bis[3-(α,α,α,α′,α′,α′,α″,α″,α″-nonafluoro-t-butyl)phenyl]-samarium β-naphthyl methyl ether complex <58.1>, tris[3-(α,α,α,α′,α′,α′,α″,α″,α″-nonafluoro-t-butyl)phenyl]-titanium β-naphthyl methyl ether complex <55.3>, tris[3(α,α,α,α′,α′,α′,α″,α″,α″-nonafluoro-t-butyl)phenyl]-zirconium β-naphthyl methyl ether complex <55.3>, bis[3-(α,α,α,α′,α′,α′,α″,α″,α″-nonafluoro-t-butyl)phenyl]-hafnium β-naphthyl methyl ether complex <55.3>, bis[3-(α,α,α,α′,α′,α′,α″,α″,α″-nonafluoro-t-butyl)phenyl]-borane β-naphthyl methyl ether complex <58.1>, bis[3-(α,α,α,α′,α′,α′,α″,α″,α″-nonafluoro-t-butyl)phenyl]-aluminum β-naphthyl methyl ether complex <58.1>, and bis[3-(α,α,α,α′,α′,α′,α″,α″,α″-nonafluoro-t-butyl)phenyl]-β-naphthyl methyl ether phosphine <58.1>, among others.

As metal catalysts containing a modified amine as a bidentate ligand, there can be mentioned dimethylglyoximato-(2,3,5,6-tetrafluorotoluenyl)yttrium <59.0>, dimethylglyoximato-(2,3,5,6-tetrafluorotoluenyl)samarium <59.0>, dimethylglyoximato-bis(2,3,5,6-tetrafluorotoluenyl)titanium <58.3>, dimethylglyoximato-bis(2,3,5,6-tetrafluorotoluenyl)zirconium <58.3>, dimethylglyoximato-bis(2,3,5,6-tetrafluorotoluenyl)hafnium <58.3>, dimethylglyoximato-(2,3,5,6-tetrafluorotoluenyl)borane <59.0>, dimethylglyoximato-(2,3,5,6-tetrafluorotoluenyl)aluminum <59.0>, and dimethylglyoximato-bis(2,3,5,6-tetrafluorotoluenyl)phosphine <59.0>, among others.

As metal catalysts containing a diamine as a bidentate ligand, there can be mentioned (2,3,5,6-tetrafluorotoluenyl)-bipyridylyttrium <58.9>, (2,3,5,6-tetrafluorotoluenyl)-bipyridylsamarium <58.9>, bis(2,3,5,6-tetrafluorotoluenyl)-bipyridyltitanium <54.2>, bis(2,3,5,6-tetrafluorotoluenyl)-bipyridylzirconium <54.2>, bis(2,3,5,6-tetrafluorotoluenyl)-bipyridylhafnium <54.2>, (2,3,5,6-tetrafluorotoluenyl)-bipyridylborane <58.9>, (2,3,5,6-tetrafluorotoluenyl)-bipyridylaluminum <58.9>, and bis(2,3,5,6-tetrafluorotoluenyl)-bipyridylphosphine <58.9>, among others.

As metal catalysts containing a diene group as a bidentate ligand, there can be mentioned tris(pentamethylcyclopentadienyl)yttrium <59.1>, tris(pentamethylcyclopentadienyl)samarium <59.1>, tris(pentamethylcyclopentadienyl)chlorotitanium <58.3>, tris(pentamethylcyclopentadienyl)chlorozirconium <58.3>, tris(pentamethylcyclopentadienyl)chorohafnium <58.3>, tris(pentamethylcyclopentadienyl)borane <59.1>, tris(pentamethylcyclopentadienyl)aluminum <59.1>, tris(pentamethylcyclopentadienyl)phosphine <59.1>, titanocene chloride <52.8>, dichloro[R,R′]-ethylenebis(4,5,6,7-tetrahydro-1-indenyl)titanium <53.1>, and tris(tetramethylcyclopentadienyl)samarium <52.7>, among others.

As metal catalysts containing a dicarbonyl as a bidentate ligand, there can be mentioned acetylacetonato-(2,3,5,6-tetrafluorotoluenyl)yttrium <57.7>, acetylacetonato-(2,3,5,6-tetrafluorotoluenyl)samarium <57.7>, acetylacetonato-bis(2,3,5,6-tetrafluorotoluenyl)titanium <56.9>, acetylacetonato-bis(2,3,5,6-tetrafluorotoluenyl)zirconium <56.9>, acetylacetonato-bis(2,3,5,6-tetrafluorotoluenyl)hafnium <56.9>, acetylacetonato-(2,3,5,6-tetrafluorotoluenyl)borane <57.7>, acetylacetonato-(2,3,5,6-tetrafluorotoluenyl)aluminum <57.7>, and acetylacetonato-(2,3,5,6-tetrafluorotoluenyl)phosphine <57.7>, among others.

As metal catalysts containing a dioxy species as a bidentate ligand, there can be mentioned (2,3,5,6-tetrafluorotoluenyl)-1,8-octanedioxyyttrium <59.5>, (2,3,5,6-tetrafluorotoluenyl)-1,8-octanedioxysamarium <59.5>, bis(2,3,5,6-tetrafluorotoluenyl)-1,8-octanedioxytitanium <58.7>, bis(2,3,5,6-tetrafluorotoluenyl)-1,8-octanedioxyzirconium <58.7>, (2,3,5,6-tetrafluorotoluenyl)-1,8-octanedioxyhafnium <58.7>, (2,3,5,6-tetrafluorotoluenyl)-1,8-octanedioxyborane <59.5>, (2,3,5,6-tetrafluorotoluenyl)-1,8-octanedioxyaluminum <59.5>, and (2,3,5,6-tetrafluorotoluenyl)-1,8-octanedioxyphosphine <59.5>, among others.

As metal catalysts containing a triamine as a tridentate ligand, there can be mentioned (2,3,5,6-tetrafluorotoluenyl)-(1,3,5-triazino)titanium <53.2>, (2,3,5,6-tetrafluorotoluenyl)-(1,3,5-triazino)zirconium <53.2>, (2,3,5,6-tetrafluorotoluenyl)-(1,3,5-triazino)hafnium <53.2>, and (2,3,5,6-tetrafluorotoluenyl)-(1,3,5-triazino)phosphine <53.2>, among others.

As metal catalysts containing a triene as a tridentate ligand, there can be mentioned (2,3,5,6-tetrafluorotoluenyl)-eicosatrienyltitanium <50.4>, (2,3,5,6-tetrafluorotoluenyl)-eicosatrienylzirconium <50.4>, and (2,3,5,6-tetrafluorotoluenyl)-eicosatrienylhafnium <50.4>, among others.

As metal catalysts containing a tetramine-derived species as a tetradentate ligand, there can be mentioned α,β-dinaphthyloctaethylporphyrino-bis(2,3,5,6-tetrafluorotoluenyl)titanium <59.5>, α,β-dinaphthyloctaethylporphyrino-bis(2,3,5,6-tetrafluorotoluenyl)zirconium <59.5>, and α,β,γ,δ-tetranaphthyloctaethylporphyrino-bis(2,3,5,6-tetrafluorotoluenyl)hafnium <59.5>, among others.

As metal catalysts containing an ether as a tetradentate ligand, there can be mentioned bis(2,3,5,6-tetrafluorotoluenyl)titanium dibenzo-18-6 crown ether complex <57.9>, bis(2,3,5,6-tetrafluorotoluenyl)zirconium dibenzo-18-6 crown ether complex <57.9>, bis(2,3,5,6-tetrafluorotoluenyl)hafnium dibenzo-18-6 crown ether complex <57.9>, and (2,3,5,6-tetrafluorotoluenyl)phosphine dibenzo-18-6 crown ether complex <57.9>, among others.

The metal catalyst of the present invention can be easily obtained by the known synthetic technology. For example, tris(3-methyltetrafluorophenyl)borane (58.0), tris(3-methyltetrafluorophenyl)aluminum (58.0), tris(o-trifluoromethylphenyl)aluminum (54.0), tetraphenyldichlorophosphine (53.9), tetrakis(pentafluorophenyl)dichlorophosphine (51.8), tetraphenyldicyanophosphine (52.7), and tetraphenyldiiodoantimony (52.1), for instance, can be synthesized by the same method as the method for synthesis of tris(pentafluorophenyl)borane as disclosed in Japanese Kokai Publication Hei-06-247978, Japanese Kokai Publication Hei-08-253485, Japanese Kokai Publication Hei-09-295984, etc. Thus, the objective metal catalyst can be obtained by mixing the substituted phenyl magnesium bromide (substituted phenyl Grignard reagent) with MAn (M denotes the metal atom of the metal catalyst, A denotes a group which may leave on reaction with the Grignard reagent, such as chloro or bromo, and n denotes the number of mols of A).

Metallocene compounds containing cyclopentadiene as a ligand, such as titanocene chloride (52.8), dichloro[R,R′]-ethylenebis(4,5,6,7-tetrahydro-1-indenyl)titanium (53.1), and tris(tetramethylcyclopentadienyl)samarium (52.7), for instance, can be obtained by the same method as the method for synthesis described in Japanese Kokai Publication Hei-03-163,088, Japanese Kokai Publication Hei-03-188,092, D. F. Bari, “Metallocenes '96”, 27 (1996), etc.

The metal catalyst of the present invention is very suitable, as a weakly cationic catalyst or a weakly anionic catalyst, for the ring-opening polymerization of heterocyclic compounds.

In conducting the ring-opening polymerization of a heterocyclic compound using a metal catalyst of the invention, a promoter, such as a trialkylaluminum (e.g. triethylaluminum, trimethylaluminum, etc.), a trialkylamine (e.g. triethylamine, etc.), or the like can be employed.

The level of use of the metal catalyst according to the present invention based on the weight of the reaction substrate (S) is preferably 0.001 to 10 weight %, more preferably 0.001 to 1.0 weight %, still more preferably 0.005 to 0.5 weight %.

In the case where a promoter is used, the level of use of the promoter based on the weight of the metal catalyst according to the invention is preferably 0.001 to 1.0 weight %, more preferably 0.001 to 0.5 weight %, and particularly preferably 0.005 to 0.1 weight %.

As the heterocyclic compound for use as the reaction substrate (S), there can be mentioned 3- through 8-membered ring compounds containing at least one heteroatom as a constituent atom of the ring.

The heteroatom includes oxygen, nitrogen, sulfur, silicon, phosphorus, arsenic, and selenium.

As the heterocyclic compound (S), compounds represented by the following general formula (1), among others, can be employed.

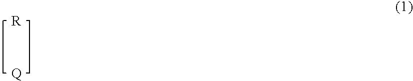

In the above general formula (1), R represents an alkylene group containing 3 to 12 (preferably 3 to 8, more preferably 3 to 6) carbon atoms, one or more hydrogen atoms of which may optionally be substituted by halogen and/or a hydrocarbon group or groups containing 1 to 10 (preferably 1 to 5, more preferably 1 to 3) carbon atoms. Q represents a bivalent organic group selected from the group consisting of —O—, —S—, —NH—, —OCOO—, —SCOO—, —OCSO—, —OCOS—, —OCSS—, —SCSS—, —SCSO—, —SCOS—, —COO—, —CSO—, —COS—, —CSS—, —CONH— and —N═C(—R′)—O— [wherein R′ represents an alkyl group containing 1 to 12 carbon atoms, a cycloalkyl group containing 5 to 15 (preferably 5 to 10, more preferably 5 to 8) carbon atoms which may optionally be substituted by alkyl containing 1 to 12 (preferably 1 to 8, more preferably 1 to 5) carbon atoms, or an aryl group containing 6 to 12 (preferably 6 to 10, more preferably 6 to 8) carbon atoms which may optionally be substituted by halogen].

The alkylene group containing 3 to 12 carbon atoms includes propylene, 1,1-dimethylpropylene, 1,2-butylene, 1,1-dimethyl-1,2-butylene, 3,4-butylene, 1,2-dimethyl-1,4-butylene, 1,2-pentylene, 1,2-hexylene, chloropropylene, and 1,12-undecylene.

The alkyl group containing 1 to 12 carbon atoms includes methyl, ethyl, butyl, hexyl, 2-ethylhexyl, decyl, undecyl, and so on.

The cycloalkyl group containing 5 to 15 carbon atoms includes cyclopentyl, cyclohexyl, 4-methylcyclohexyl, 4-hexylcyclohexyl, and the like.

The aryl group containing 6 to 12 carbon atoms includes phenyl, 4-chlorophenyl, pentachlorophenyl, pentafluorophenyl, trifluoromethylphenyl, naphthyl, 3,5-methylnaphthyl, and the like.

As examples of the compound represented by the general formula (1), the following compounds can be mentioned.

(1) Cyclic Ethers (Q: —O—)

Propylene oxide, 1,2-butylene oxide, 3,4-butylene oxide, oxetane, 1,2-dichlorooxetane, 1,2-pentylene oxide, 1,2-hexylene oxide, tetrahydrofuran, styrene oxide, cyclohexene oxide, epichlorohydrin, epibromohydrin, methyl glycidyl ether, allyl glycidyl ether, and phenyl glycidyl ether, among others.

(2) Cyclic Thio Ethers (Q: —S—)

Ethylene sulfide, propylene sulfide, 1,2-butylene sulfide, 2,3-butylene sulfide, 1,2-pentene sulfide, cyclohexene sulfide, styrene sulfide, epichlorothiosulfide, epibromothiosulfide, perchloropropylene sulfide, and allylglycidyl thiosulfide, among others.

(3) Cyclic Amines (Q: —NH—)

Ethyleneimine, propyleneimine, 1,2-butyleneimine, 2,3-butyleneimine, 1,2-penteneimine, cyclohexeneimine, styreneimine, epichloroimine, epibromoimine, phenylimine, toluylimine, and allylglycidylimine, among others.

(4) Cyclic Carbonates (Q: —OCOO—)

Ethylene carbonate, propylene carbonate, iso-butylene carbonate, phenylene carbonate, hexene carbonate, and 1,2-chloropropylene carbonate, among others.

(5) Thiocarbonates (Q: —OCOS—)

Ethylene thiocarbonate, propylene thiocarbonate, isobutylene thiocarbonate, and 1,2-chloropropylene carbonate, among others.

(6) Lactones (Q: —COO—)

ε-Caprolactone, butyrolactone, γ-valerolactone, δ-valerolactone, chloro-ε-caprolactone, and heptolactone, among others.

(7) Thio Lactones (Q: —COS—)

Propiothiolactone, butylthiolactone, 1-methyl-butylthiolactone, dichloropropylthiolactone, trichlorobutylthiolactone, pentylthiolactone, chlorobutylthiolactone, and hexylthiolactone, among others.

(8) Lactams (Q: —CONH—)

ε-Caprolactam, γ-butyrolactam, γ-valerolactam, δ-valerolactam, heptolactam, glycocyamidine, oxindole, chloro-ε-caprolactam, and isatin, among others.

(9) Cyclic Oxazoles (Q: —N═C(—R′)—O—)

Oxazole, methyloxazole, propyloxazole, butyloxazole, sec-butyloxazole, t-butyloxazole, pentyloxazole, sec-pentyloxazole, among others.

Among these cyclic compounds, cyclic ethers, cyclic thio ethers, cyclic amines and lactones are preferred, and cyclic ethers and cyclic thio ethers are still more preferred, with cyclic ethers being particularly preferred and cyclic ethers containing 3 to 6 carbon atoms being most preferred.

By means of the metal catalyst of the invention, the heterocyclic compound (S) may also be caused to form an adduct compound with an active hydrogen-containing organic compound.

The active hydrogen-containing organic compound is not particularly restricted provided that it reacts with the heterocyclic compound to form a heterocyclic compound adduct, but may for example be an alcohol, a thioalcohol, a phenol, a thiophenol, an amine, a carboxylic acid or an amide.

The adduct of the heterocyclic compound to such an active hydrogen-containing compound (initiator) can also be used as an initiator insofar as it retains active hydrogen.

The alcohol mentioned above includes monohydric alcohols, dihydric alcohols, and tri- or polyhydric alcohols.

The monohydric alcohol which can be used includes alcohols containing 1 to 20 (preferably 1 to 15, more preferably 5 to 15) carbon atoms, such as methanol, ethanol, n-propanol, butanol, 2-ethylhexyl alcohol, cyclohexanol, benzyl alcohol, and eicosyl alcohol, among others.

The dihydric alcohol includes alcohols containing 2 to 20 (preferably 2 to 10, more preferably 2 to 10) carbon atoms, such as ethylene glycol, propylene glycol, 1,4-butanediol, 1,6-hexanediol, diethylene glycol, neopentyl glycol, hexanediol, and eicosanediol, among others.

The trihydric alcohol includes alcohols containing 3 to 20 (preferably 3 to 15, more preferably 3 to 10) carbon atoms and those hydroxyl group-containing polymers which have weight average molecular weights between 100 and 1,000, such as glycerin, diglycerin, triglycerin, pentaglycerin, trimethylolpropane, dimethylolpropane, pentaerythritol, dipentaerythritol, sorbitan, sorbitol, fructose, and sucrose. In addition, polyvinyl alcohols having weight average molecular weights between 100 and 1,000 can be mentioned.

The thioalcohol includes thioalcohols containing 1 to 20 (preferably 1 to 15, more preferably 5 to 15) carbon atoms, such as methyl mercaptan, ethyl thioalcohol, propyl thioalcohol, butyl thioalcohol, pentyl thioalcohol, hexyl thioalcohol, heptyl thioalcohol, octyl thioalcohol, nonyl thioalcohol, dodecyl thioalcohol, isopropyl thioalcohol, isobutyl thioalcohol, t-butyl thioalcohol, and t-octyl thioalcohol, among others.

The phenol includes phenols containing 6 to 20 (preferably 6 to 15, more preferably 6 to 10) carbon atoms, such as phenol, nonylphenol, octylphenol, dinonylphenol, naphthol, hydroquinone, catechol, resorcin, bisphenol A, triphenol, and tetraphenol, among others.

The thiophenol includes thiophenols containing 6 to 20 (preferably 6 to 15, more preferably 6 to 10) carbon atoms, such as thiophenol, o-tolyl thioalcohol, p-tolyl thioalcohol, 2,3-xylyl thioalcohol, 2,4-xylyl thioalcohol, 3,4-xylyl thioalcohol, 4-ethylthiophenol, and 2-naphthyl thioalcohol, among others.

The amine includes ammonia, alkanolamines, aliphatic amines, aromatic amines, and heterocyclic amines.

The alkanolamine referred to just above includes alkanolamines containing 2 to 12 (preferably 2 to 8, more preferably 2 to 5) carbon atoms, such as monoethanolamine, diethanolamine, triethanolamine, monoisopropanolamine, and butanolamine, among others.

The aliphatic amine referred to above includes monoalkylamines containing 1 to 20 (preferably 1 to 10, more preferably 1 to 5) carbon atoms, dialkylamines containing 2 to 20 (preferably 2 to 10, more preferably 2 to 5) carbon atoms, and alkylenepolyamines containing 2 to 20 (preferably 2 to 10, more preferably 2 to 5) carbon atoms.

The monoalkylamine referred to just above includes methylamine, ethylamine, butylamine, 2-ethylhexylamine, octadecylamine, eicosylamine, and so on.

The dialkylamine includes dimethylamine, diethylamine, methylethylamine, 2-ethylhexylmethylamine, methyloctadecylamine, octadecylethylamine, and so on.

The alkylenepolyamine includes alkylenepolyamines containing 2 to 20 carbon atoms, such as ethylenediamine, hexamethylenediamine, octamethylenediamine, isophoronediamine, cyclohexylenediamine, diethylenetriamine, triethylenetetramine, and so on.

The aromatic amine includes arylamines, arylalkylamines, arylenepolyamines which contain 6 to 20 (preferably 6 to 15, more preferably 6 to 10) carbon atoms, and so on.

The arylamine referred to just above includes aniline, N-methylaniline, o-toluidine, m-toluidine, N-ethyltoluidine, p-toluylamine, 2,3-xylinoamine, 2,4-xylinoamine, diphenylamine, methylphenylamine, ethylphenylamine, di-o-toluylamine, and phenyltoluylamine.

The arylalkylamine includes benzylamine, benzylmethylamine, o-toluylmethylamine, and so on.

The arylenepolyamine includes phenylenediamine, diaminotoluene, xylylenediamine, methylenedianiline, diphenyl ether diamine, and so on.

The heterocyclic amine which can be used includes heterocyclic amines containing 5 to 20 carbon atoms, such as aminoethylpiperazine and the heterocyclic amines described in Japanese Kokoku Publication Sho-55-21044.

The carboxylic acid which can be used includes aliphatic carboxylic acids, aromatic carboxylic acids, and so on.

The aliphatic carboxylic acid referred to just above includes monocarboxylic acids, dicarboxylic acids, polycarboxylic acids, and the like.

The aliphatic monocarboxylic acid referred to just above includes monocarboxylic acids containing 1 to 20 (preferably 1 to 10, more preferably 1 to 5) carbon atoms, such as formic acid, acetic acid, propionic acid, octanoic acid, 2-ethylhexanoic acid, octadecanoic acid, and eicosanoic acid, among others.

The aliphatic dicarboxylic acid which can be used includes dicarboxylic acids containing 2 to 30 (preferably 2 to 15, more preferably 2 to 10) carbon atoms, such as oxalic acid, succinic acid, adipic acid, sebacic acid, maleic acid, and so on.

The aliphatic polycarboxylic acid which can be used includes polycarboxylic acids containing 6 to 30 (preferably 6 to 20, more preferably 6 to 15) carbon atoms. For example, there can be mentioned hexanetricarboxylic acid, octanetricarboxylic acid, hexanetetracarboxylic acid, and the like. Aside from these, poly(meth)acrylic acid, polymaleic acid, methacrylic acid-maleic acid copolymer, and methyl methacrylate-(meth)acrylic acid copolymer, within the weight average molecular weight range of 100 to 2,000, can be mentioned.

The aromatic carboxylic acid which can be used includes monocarboxylic acids, dicarboxylic acids, and polycarboxylic acids.

The aromatic monocarboxylic acid referred to just above includes monocarboxylic acids containing 7 to 20 (preferably 7 to 15, more preferably 7 to 10) carbon atoms, such as benzoic acid, 4-methylbenzoic acid, 2,3,4-trichlorobenzoic acid, and naphthalenecarboxylic acid, among others.

The aromatic dicarboxylic acid includes dicarboxylic acids containing 7 to 30 (preferably 7 to 20, more preferably 7 to 15) carbon atoms, such as phthalic acid, terephthalic acid, trichlorobenzenedicarboxylic acid, m-toluenedicarboxylic acid, and naphthalenedicarboxylic acid, among others.

The aromatic polycarboxylic acid which can be used includes polycarboxylic acids containing 7 to 30 (preferably 7 to 20, more preferably 7 to 15) carbon atoms, such as trimellitic acid, 1,2,4,5-benzenetetracarboxylic acid, benzenehexacarboxylic acid, and naphthalenetetracarboxylic acid, among others. Aside from these, poly(4-carboxystyrene) having a weight average molecular weight of 15 to 2,000, among others, can also be mentioned.

The amide which can be used includes amides containing 1 to 20 (preferably 1 to 15, more preferably 1 to 10) carbon atoms, such as acetamide, ethylamide, propylamide, methylethylamide, butylamide, and benzamide, among others.

As the adduct compound obtainable by addition of the heterocyclic compound to such an active hydrogen-containing compound (initiator), there can be used polyalkylene glycols, alcohol-alkylene oxide adducts, carboxylic acid-alkylene oxide adducts, and amine-alkylene oxide adducts, among others.

The polyalkylene glycol which can be used includes glycols within the weight average molecular weight range of 88 to 3,000, such as diethylene glycol, triethylene glycol, dipropylene glycol, polyoxyethylene glycol, polyoxypropylene glycol, polyoxyethylene-polyoxypropylene glycol (oxyethylene/oxypropylene: weight ratio 10/90, block), polyoxyethylene-polyoxybutylene glycol (oxyethylene/oxybutylene: weight ratio 50/50, random), and the like.

The alcohol-alkylene oxide adduct includes methanol polyethylene oxide adduct, methanol polypropylene oxide adduct, ethanol polyethylene oxide adduct, ethanol polypropylene oxide adduct, propyl alcohol polyethylene oxide adduct, propyl alcohol polypropylene oxide adduct, glycerin polyethylene oxide adduct, glycerin polypropylene oxide adduct, and the like.

The carboxylic acid-alkylene oxide adduct includes 2-hydroxyethyl (meth)acrylate, 2-hydroxypropyl (meth)acrylate, formic acid polyethylene oxide adduct, formic acid polypropylene oxide adduct, 2-ethylhexanoic acid polyethylene oxide adduct, 2-ethylhexanoic acid polypropylene oxide adduct, oxalic acid polyethylene oxide adduct, oxalic acid polypropylene oxide adduct, and the like.

These active hydrogen-containing compounds can be used optionally in a combination of two or more species.

In conducting a ring-opening addition reaction using the catalyst of the invention, a solvent may be used where necessary.

As the solvent, any of those solvents which are used for conventional ring-opening addition reactions can be utilized as it is.

When a solvent is used, its level of use based on the weight of the heterocyclic compound (S) is preferably 10 to 80 weight %, more preferably 30 to 60 weight %, still more preferably 40 to 50 weight %.

The reaction temperature is preferably 0 to 100° C., more preferably 20 to 90° C., still more preferably 40 to 80° C.

The reaction pressure is preferably 10 to 100 Pa, more preferably 20 to 80 Pa, still more preferably 20 to 50 Pa.

The ring-opening addition reaction in the presence of the catalyst of the invention can be carried out in the same manner as the conventional ring-opening addition reaction. Thus, there can be mentioned (1) the method in which the heterocyclic compound is added portionwise to a mixture (prepared to be the reaction temperature in advance) of the active hydrogen-containing organic compound, the catalyst of the invention, and the solvent to be used where necessary for ring-opening addition reaction, (2) the method in which the heterocyclic compound, the active hydrogen-containing organic compound, the catalyst of the invention, and the solvent to be used where necessary are admixed in one operation and adjusted to the reaction temperature, and (3) the method in which the active hydrogen-containing organic compound obtained by the above method (1) or (2) is retained in the reaction vessel and a different kind of heterocyclic compound is further introduced for ring-opening addition reaction.

Furthermore, after the ring-opening addition reaction, the catalyst can be removed by adsorption with an adsorbent (for example, activated clay, zeolite, synthetic zeolite, an ion exchange resin, or the like) or filtration, and the reaction mixture may be neutralized with, for example, a mineral acid, an organic acid, an amine, or an alkali metal hydroxide.

The heterocyclic compound ring-opened polymer produced by using the catalyst of the invention has a high ratio of primary terminal heteroatomic groups (not less than 75% or even 80% or higher), so that, when used as a starting material to be reacted with another starting material, it exhibits high reactivity to give a product having desired properties with greater certainty. Therefore, the polymer is of great use particularly as a raw material of various derivatives such as polymer dispersion polyols, isocyanato-terminated prepolymers, polyurethane resins, polyoxyalkylenepolyamines, and polyurethaneurea resins using said polyoxyalkylenepolyamines as raw materials.

The ratio of primary functional groups means the percentage of primary functional groups (functional groups directly attached to methylene groups) based on the total terminal functionality of the ring-opened polymer. Taking propylene oxide as an example of said heterocyclic compound, the ratio of primary functional groups means the percentage (mol %) of the primary hydroxyl group {—CH(CH₃)CH₂OH} based on the total terminal hydroxyl function of the ring-opened polymer.

The ratio of primary terminal heteroatomic groups can be calculated by ¹H-NMR analysis, after the pretreatment esterification of a sample. Thus, the percentage of the section containing the methylene group attached to the primary terminal heteroatomic group of the ring-opened polymer relative to the sum of the section containing the methylene group attached to the primary terminal heteroatomic group and the section containing the methyne group attached to the secondary terminal heteroatomic group of the ring-opened polymer is determined by ¹H-NMR spectrum analysis and the result is taken as the ratio of primary terminal heteroatomic groups.

The metal catalyst of the invention is so high in reaction activity that a reaction can be sufficiently realized at a comparatively low temperature (40 to 80° C.) with a small catalyst amount (30 to 100 pm) to give a ring-opened polymer with a narrow molecular weight distribution.

When the ring-opened polymer of the invention is further allowed to the ring-opening polymerization of ethylene oxide, the proportion of primary functional groups (primary hydroxyl groups) can be easily increased to at least 80% or even at least 95%. Moreover, by causing ethylene oxide to undergo ring-opening polymerization in a proportion of 1 to 10 units (preferably 2 to 6 units, more preferably 2 to 5 units) per unit of the terminal functional group of the ring-opened polymer of the invention, it is possible to obtain an ring-opened polymer containing primary hydroxyl groups in a proportion of as high as not less than 80% or even 95% or higher and, as determined by the method of Oda (R. Oda & K. Teramura, Kaimenkassei-zai no Gosei to Sono Oyo (Synthesis of Surfactants and Its Application), p.501, Maki Shoten; Takehiko Fujimoto, Shin Kaimenkassei-zai Nyumon (New Introduction to Surfactants), p.197, published by Sanyo Chemical Industries, Ltd.), having a hydrophile-lipophile balance (HLB) number of 4 to 7. The ring-opened polymer having such a structure exhibits unusually high reactivity with isocyanates when used, as it is, as a raw material for urethane foams and features a low deflection set by constant compression under moist and hot condition.

### BEST MODE FOR CARRYING OUT THE INVENTION

The following examples illustrate the present invention in further detail without defining the scope of the invention. In the following description, all “parts” and “percents” represent weight parts and weight %, respectively.

### EXAMPLE 1

A stainless steel autoclave equipped with stirring and temperature control functions was charged with 1,000 parts of polypropylene glycol (weight average molecular weight 1,000, 1 mol part) and 0.01 parts of tris(3-methyltetrafluorophenyl)borane, which is one of the organometal catalysts according to the invention. After substitution in the system by nitrogen, the system was dehydrated under reduced pressure (about 20 mmHg) at 120° C. for 1 hour.

Then, 290 parts (5 mol parts) of propylene oxide was introduced under a constant gauge pressure of 1 to 3 kgf/cm² at 60° C. and, thereafter, the mixture was subjected to maturing reaction at 60° C. for one hour.

To this reaction mixture was added 3 parts of an adsorbent (Kyowaad™ 1000, product of Kyowa Chemical Industry Co., Ltd.) for adsorbing the catalyst at 90° C., followed by filtering to give a propylene oxide ring-opened polymer (I).

The ratio of primary functional groups in the open ring polymer (I) as determined by ¹H-NMR spectrum analysis was 80%.

### EXAMPLE 2

Except that titanocene chloride was used in lieu of tris(3-methyltetrafluorophenyl)borane used in Example 1, the procedure of Example 1 was repeated to give a heterocyclic compound ring-opened polymer (II).

The ratio of primary functional groups in the ring-opened polymer (II) as determined by ¹H-NMR spectrum analysis was 89%.

### EXAMPLE 3

Except that 62.1 parts (1 mol part) of diethylene glycol was used in lieu of 1,000 parts of polypropylene glycol used in Example 2, the procedure of Example 2 was repeated to give a heterocyclic compound ring-opened polymer (III).

The ratio of primary functional groups in the ring-opened polymer (III) as determined by ¹H-NMR spectrum analysis was 88%.

### EXAMPLE 4

Except that tetrakis[2,4-di(trifluoromethyl)trifluorophenyl]phosphine was used in lieu of tris(3-methyltetrafluorophenyl)borane used in Example 1, the procedure of Example 1 was repeated to give a heterocyclic compound ring-opened polymer (IV).

The ratio of primary functional groups in the ring-opened polymer (IV) as determined by ¹H-NMR spectrum analysis was 95%.

### EXAMPLE 5

Except that 1,2-butylene oxide was used in lieu of propylene oxide used in Example 1, the procedure of Example 1 was repeated to give a heterocyclic compound ring-opened polymer (V).

The ratio of primary functional groups in the ring-opened polymer (V) as determined by ¹H-NMR spectrum analysis was 82%.

### COMPARATIVE EXAMPLE 1

A stainless steel autoclave equipped with stirring and temperature control functions was charged with 1,000 parts of polypropylene glycol (weight average molecular weight 1,000, 1 mol part) and 0.01 parts of tris(pentafluorophenyl)borane, and after substitution in the system by nitrogen, the system was dehydrated under reduced pressure (about 20 mmHg) at 120° C. for 1 hour.

Then, 290 parts (5 mol parts) of propylene oxide was introduced under a constant gauge pressure of 1 to 3 kgf/cm² at 60° C. and the system was subjected to maturing reaction at 60° C. for 1 hour.

To this reaction mixture was added 3 parts of an adsorbent (Kyowaad™ 1000, product of Kyowa Chemical Industry Co., Ltd.) for adsorbing the catalyst at 90° C., followed by filtering to give a heterocyclic compound ring-opened polymer (VI).

The ratio of primary functional groups in the ring-opened polymer (VI) as determined by ¹H-NMR spectrum analysis was 73%.

### COMPARATIVE EXAMPLE 2

Except that 0.03 parts of tris(t-butyl)boron was used in lieu of tris(pentafluorophenyl)borane used in Comparative Example 1, the procedure of Comparative Example 1 was repeated to give a heterocyclic compound ring-opened polymer (VII).

The ratio of primary functional groups in the ring-opened polymer (VII) as determined by ¹H-NMR spectrum analysis was 69%.

### COMPARATIVE EXAMPLE 3

Except that 1,2-butylene oxide was used in lieu of propylene oxide used in Comparative Example 1, the procedure of Comparative Example 1 was repeated to give a heterocyclic compound ring-opened polymer (VIII).

The ratio of primary functional groups in the ring-opened polymer (VIII) as determined by ¹H-NMR spectrum analysis was 70%.

The metal catalysts used in Examples 1 to 5 and Comparative Examples 1 to 3, the smallest maximum angles (Dm) thereof, the initiators and heterocyclic compounds used, and the ratio of primary terminal hydroxyl groups of each resulting ring-opened polymer are presented in Table 1.

The smallest maximum angle (Dm) was determined by molecular dynamics computation (MM2) (T. Clark: A Handbook of Computational Chemistry, Maruzen; Sakurai, M. & Ikai, A.: Seibutsu-kogaku Kiso Course, Keisan-ki-kagaku Nyumon (Fundamental Course in Biotechnology, Introduction to Computerized Chemistry), Maruzen).

<Method for Determination of the Ratio of Primary Terminal Hydroxyl Groups>

Sample preparation: About 30 mg of the material to be analyzed was weighed out into a 5 mm-diameter ¹H-NMR sample tube and dissolved by adding about 0.5 ml of a deuterated solvent. Then, about 0.1 ml of trifluoroacetic anhydride was added to the solution and the mixture was allowed to stand at 25° C. for about 5 minutes. The resulting trifluoroacetic acid ester was used as a sample for analysis.

The deuterated solvent mentioned above means deuterated chloroform, deuterated toluene, deuterated dimethyl sulfoxide, deuterated dimethylformamide, or the like and, among these, a solvent capable of dissolving the sample was selected.

Determination of the ratio of primary terminal hydroxyl group: NMR spectrum analysis: a ¹H-NMR spectrum was recorded under the conventional conditions.

The signal assignable to methylene attached to primary hydroxyl is observed at about 4.3 ppm and the signal assignable to methyne attached to secondary hydroxyl appears at about 5.2 ppm. Therefore, the ratio (%) of primary terminal hydroxyl groups is calculated by means of the following equation.

(the ratio(%)of primary terminal hydroxyl groups)=[a/(a+2×b)]×100

a: the integrated signal value assignable to methylene attached to primary hydroxyl at about 4.3 ppm.

b: the integrated signal assignable to methyne attached to secondary hydroxyl at about 5.2 ppm.

TABLE 1

| | | | | | Ratio of |
|---|---|---|---|---|---|
| | | | The smallest | Heterocyclic | primary |
| | Metal catalyst | | maximum angle | compound | functional |
| | (Catalyst amount: mmol/g) | Initiator | (Dm in degrees) | (S) | group |
| Example | | | | | |
| 1 | Tris- | Polypropylene | 58.0 | Propylene | 80% |
| | (3-methyltetrafluorophenyl)- | glycol | | oxide | |
| | borane (0.002) | (Mw 1,000) | | | |
| 2 | Titanocene chloride | Polypropylene | 52.8 | Propylene | 89% |
| | (0.010) | glycol | | oxide | |
| | | (Mw 1,000) | | | |
| 3 | Titanocene chloride | Diethylene | 52.8 | Propylene | 88% |
| | (0.010) | glycol | | oxide | |
| 4 | Tetrakis- | Polypropylene | 42.2 | Propylene | 95% |
| | [2,4-di(trifluoromethyl)- | glycol | | oxide | |
| | trifluorophenyl]phosphine | (Mw 1,000) | | | |
| | (0.011) | | | | |
| 5 | Tris- | Polypropylene | 58.0 | 1,2-Butylene | 82% |
| | (3-methyltetrafluorophenyl)- | gylcol | | oxide | |
| | borane (0.005) | (Mw 1,000) | | | |
| Comparative | | | | | |
| Example | | | | | |
| 1 | Tris(pentafluorophenyl)- | Polypropylene | 64.4 | Propylene | 73% |
| | borane | glycol | | oxide | |
| | (0.002) | (Mw 1,000) | | | |
| 2 | Tris(t-butyl)borane | Polypropylene | 65.1 | Propylene | 69% |
| | (0.013) | glycol | | oxide | |
| | | (Mw 1,000) | | | |
| 3 | Tris(pentafluorophenyl)borane | Polypropylene | 64.4 | 1,2-Butylene | 70% |
| | (0.002) | glycol | | oxide | |
| | | (Mw 1,000) | | | |

In the Table, Mw stands for weight average molecular t as determined by gel permeation chromatography. The catalyst amount is expressed in the amount (mmol) e catalyst per gram of the heterocyclic compound (S).

### INDUSTRIAL APPLICABILITY

The ring-opened polymer of a heterocyclic compound as produced in the presence of the catalyst of the invention has an unusually high ratio of primary terminal heteroatomic groups so that, when used as a starting material to be reacted with a different material, it exhibits high reactivity to give a product having desired physical properties with greater certainty. Therefore, the polymer is-of great use as a raw material for various derivatives such as polymer dispersion polyols, isocyanato-terminated prepolymers, polyurethane resins, raw materials for polyurethane foams, and polyurethaneurea resins made from polyoxyalkylenepolyamines, among others.

1. A metal catalyst comprising a ligand and a metal atom for ring-opening polymerization of heterocyclic compounds
in which, of all maximum angles (D) meeting the following definition, the smallest maximum angle (Dm) is not larger than 60 degrees;
The maximum angle (D) is the largest angle between an imaginary line (X) and an imaginary line (Y) of all the angles which can be assumed in a metal catalyst comprising a ligand and a metal atom,
said imaginary line (X) means a line perpendicular to an imaginary plane (P) including the respective centers of 3 coordinating atoms among those directly coordinating the metal atom (M) and not substitutable by a reaction substrate (S) and passing through the center of the metal atom,
said imaginary line (Y) means a line linking the center of a non-coordinating atom in the ligand and the center of the metal atom,
and said maximum angle (D) exists in a number equal to the number of non-coordinating atoms, that is, the number of imaginary lines (Y).

2. The metal catalyst according to claim 1,
wherein the electronegativity of the metal atom is 8 to 16.

3. The metal catalyst according to claim 1 or 2
which has a 3- or 6-coordinate structure.

4. A ring-opened polymer having a ratio of primary functional groups of at least 75%
which is obtainable by the ring-opening polymerization of a heterocyclic compound(s) of the following general formula (1) in the presence of the metal catalyst according to any of claims 1 to 3; 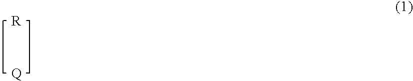
in the above general formula (1), R represents an alkylene group containing 3 to 12 carbon atoms, one or more hydrogen atoms of which may optionally be substituted by halogen and/or a hydrocarbon group or groups; Q represents a bivalent organic group selected from the group consisting of —O—, —S—, —NH—, —OCOO—, —SCOO—, —OCSO—, —OCOS—, —OCSS—, —SCSS—, —SCSO—, —SCOS—, —COO—, —CSO—, —COS—, —CSS—, —CONH— and —N═C(—R′)—O—; in the latest formula, R′ represents an alkyl group containing 1 to 12 carbon atoms, a cycloalkyl group containing 5 to 15 carbon atoms which may optionally be substituted by alkyl, or an aryl group containing 1 to 12 carbon atoms which may optionally be substituted by halogen atom.

5. A ring-opened polymer having a structure resulting from the addition by ring-opening polymerization of ethylene oxide to the ring-opened polymer according to claim 4,
wherein the ring-opened polymer having said structure has a hydrophile-lipophile balance (HLB) number of 4 to 7 as determined by the method of Oda and a ratio of primary terminal hydroxyl groups of at least 80% relative to all hydroxyl groups therein.

6. A method of producing an ring-opened polymer
which comprises subjecting a heterocyclic compound (S) of general formula (1) and/or ethylene oxide to ring-opening polymerization in the presence of the metal catalyst according to any of claims 1 to 3; 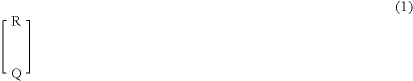
in the above general formula (1), R represents an alkylene group containing 3 to 12 carbon atoms, one or more hydrogen atoms of which may optionally be substituted by a halogen atom and/or a hydrocarbon group; Q represents a bivalent organic group selected from the group consisting of —O—, —S—, —NH—, —OCOO—, —SCOO—, —OCSO—, —OCOS—, —OCSS—, —SCSS—, —SCSO—, —SCOS—, —COO—, —CSO—, —COS—, —CSS—, —CONH— and —N═C(—R′)—O—; in the latest formula, R′ represents an alkyl group containing 1 to 12 carbon atoms, a cycloalkyl group containing 5 to 15 carbon atoms which may optionally be substituted by alkyl, or an aryl group containing 1 to 12 carbon atoms which may optionally be substituted by halogen).
